(19) United States
(12) Patent Application Publication
(10) Pub. No.: US 2006/0069535 A1
(43) Pub. Date: Mar. 30, 2006

(54) System and method for converting data, and system and method for providing warning signals

(75) Inventor: Zaruhi Roberti Mnatsakanyan, Syracuse, NY (US)

Correspondence Address: BURR & BROWN, PO BOX 7068, SYRACUSE, NY, 13261-7068, US

(73) Assignee: SENSIS CORPORATION, East Syracuse, NY (US)

(21) Appl. No.: 11/147,995

(22) Filed: Jun. 8, 2005

Related U.S. Application Data
(60) Provisional application No. 60/578,277, filed on Jun. 9, 2004.
(60) Provisional application No. 60/619,725, filed on Oct. 18, 2004.
(60) Provisional application No. 60/620,191, filed on Oct. 19, 2004.
(60) Provisional application No. 60/636,775, filed on Dec. 15, 2004.
(60) Provisional application No. 60/642,379, filed on Jan. 7, 2005.

(51) Int. Cl. G06F 17/10

(52) U.S. Cl. 703/2

(57) ABSTRACT

Methods and apparatus for converting data. In one aspect, an apparatus comprises at least one sensor, a data evaluation component, a general report generating component, a system-specific report generating component and a decision-making component. The data evaluation component generates data information based on evaluation of data from the sensor or sensors. The general reports are based on expert information and the data information. The system-specific reports are based on expert information, information pertaining to the system and the data information. The decision-making component makes decisions based on data from the sensor or sensors, the data information, the general reports and the system-specific reports. Also, data converting components and methods.

### CROSS-REFERENCE TO RELATED APPLICATIONS

This application claims the benefit of U.S. Provisional Patent Application No. 60/578,277, filed Jun. 9, 2004, the entirety of which is incorporated herein by reference.

This application claims the benefit of U.S. Provisional Patent Application No. 60/619,725, filed Oct. 18, 2004, the entirety of which is incorporated herein by reference.

This application claims the benefit of U.S. Provisional Patent Application No. 60/620,191, filed Oct. 19, 2004, the entirety of which is incorporated herein by reference.

This application claims the benefit of U.S. Provisional Patent Application No. 60/636,775, filed Dec. 15, 2004, the entirety of which is incorporated herein by reference.

This application claims the benefit of U.S. Provisional Patent Application No. 60/642,379, filed Jan. 7, 2005, the entirety of which is incorporated herein by reference.

### FIELD OF THE INVENTION

The present invention relates to methods and apparatus which convert data, as well as to methods and apparatus for providing warning signals. The present invention is further directed to methods and apparatus which receive data from one or more sensor and/or from one or more source of information, and predict, as early as possible, emergencies or other situations which require action.

### BACKGROUND OF THE INVENTION

There exist a variety of systems which gather data and attempt to identify emergencies or other situations which require action. Frequently, such data is obtained from sensors, databases or the like, which may produce an enormous amount of data. However, it is inefficient and in some cases impossible to process each piece of information substantially simultaneously and in real-time from hours of recorded data. Also, simple calculations of average values do not always give an accurate picture.

### BRIEF SUMMARY OF THE INVENTION

In accordance with one aspect of the present invention, there is provided a computer-readable medium having computer-executable components for converting data relating to a specific system, comprising: a data evaluation component which generates converted data information based on evaluation of data; a general report generating component which receives data information from the data evaluation component and expert information, and which generates general reports based on the expert information and the data information; a system-specific report generating component which receives information pertaining to the specific system and expert information, and which generates system-specific reports based on the expert information, the information pertaining to the specific system and data information received from the data evaluation component; and a decision-making component which makes decisions based on data information from the data evaluation component, the general reports and the system-specific reports.

The systems which can be monitored according to the present invention can include generally any system for which there is a desire to monitor (over long periods and/or dynamically), and for which information which is useful in performing such monitoring can be obtained by collecting data as to one or more parameter which can be measured, detected or otherwise sensed. For instance, systems which can be monitored according to the present invention include, for instance, humans (e.g., medical monitoring, body-building, exercising, mental abilities), the earth (e.g., global warming, weather patterns, air quality), the solar system, roadways (e.g., traffic flow, deterioration), polling (e.g., political elections, television programming), etc.

The apparatus preferably further comprises one or more sensors which collect data relating to one or more parameters, respectively, of or relating to the system. The methods and apparatuses according to the present invention are used to evaluate that data (1) to provide early warnings when there is a high likelihood of an emergency situation arising in the near future, (2) to advise that an emergency situation is present, and/or (3) to provide other analyses of the system or the data.

The data evaluation component generates data information which includes analyses of the data in specific formats, and provides such information to the general report generating component, the system-specific report generating component and the decision-making component.

The general report generating component generates general reports based on (1) expert information relating to the type of system being evaluated and (2) data information received from the data evaluation component.

The system-specific report generating component generates system-specific reports based on (1) expert information relating to the type of system being evaluated, (2) data information received from the data evaluation component, and (3) information pertaining to the specific system (as opposed to the type of system) being evaluated.

The decision-making component makes decisions based on (1) data information from the data evaluation component, (2) the general reports and (3) the system-specific reports.

The result is that the system-specific reports may be shifted from the general reports as a result of the information regarding the specific system. For example, in cases where the system is a human patient who is being monitored medically, based on expert information that elderly persons are more prone to high blood pressure, and specific system information that the patient is elderly, the system-specific report generating component can be configured to attribute less significance to a minor increase in the patient's blood pressure.

In one aspect of the present invention, the data evaluation component takes an initial set of data values (obtained from at least one sensor), and removes all data values which exceed a maximum possible value or which are below a minimum possible value (i.e., to remove incorrect values, e.g., values which can only have been obtained as a result of a sensor error or the like). The data evaluation component preferably determines whether a significant number of the data values in the initial set are outside of an “acceptable” range. If a significant number of the data values in the initial set are within the acceptable range, the data evaluation component preferably generates a “basic record”, which identifies a basic range (preferably within the acceptable range and which preferably encompasses fewer values than the acceptable range) within which a significant number of the data values in the initial set fall. The basic record is thus a baseline for the specific system being analyzed, against which subsequent “current records” can be compared, to help to see whether the data reflects a trending away from the original condition of the system, and possible movement toward a changed circumstance (and possibly an emergency situation). The data evaluation component preferably receives subsequent sets of data values, and examines whether significant quantities of data values are in specific ranges defined outside of the basic range and/or outside of the acceptable range. By evaluating the quantity of data values in a variety of such ranges established by the data evaluation component based on the data received, the data evaluation component selects from among different algorithms for generating data information in specific formats (examples of which are described in detail below), each format being useful in evaluating trends in the data values.

The present invention further provides methods for converting data into any of various reports, as well as components which are useful in converting data. The present invention further provides computer-readable media comprising computer instructions which, when executed by a computer, perform methods of converting data into any of various reports. The present invention further provides computer-readable media having computer-executable components as described herein. The present invention further provides methods and apparatus which provide warning signals regarding conditions and/or potential emergencies.

The invention may be more fully understood with reference to the accompanying drawings and the following detailed description of the invention.

### BRIEF DESCRIPTION OF THE DRAWING FIGURES

FIG. 1 is a schematic diagram of a system for evaluating data according to an embodiment of the present invention.

FIG. 2 is a schematic flowchart depicting an algorithm for determining the segments included in a “final range” in accordance with an embodiment of the present invention.

FIG. 3 is a schematic diagram depicting the architecture of a DataAgent component according to an embodiment of the present invention.

FIG. 4 is a schematic diagram depicting the architecture of GeneralNET and PersonalNET components for an embodiment of the present invention.

FIG. 5 is a schematic diagram depicting the architecture of an ArbiterAgent component of an inference engine according to an embodiment of the present invention.

FIG. 6 is a chart showing readings for a patient in the course of a hypothetical example relating to the present invention.

### DETAILED DESCRIPTION OF THE INVENTION

The present invention provides a solution by generating specific records and images, showing basic ranges for statistical values. In accordance with the present invention, a potential problem is detected by comparing new readings (statistical values) with previously recorded readings to generate information which is easily understood and of a more manageable quantity.

In accordance with the present invention, in order to detect potential problems, raw data incoming from one or more sensors is converted and evaluated to form statistical values. The first step in this process is to establish the framework of analysis by identifying the basic and acceptable ranges of statistical values. The “acceptable range” of statistical values is the range between (and including) minimum and maximum values at which the system can typically function normally (for example, where the system is a patient, an acceptable range for the patient's heart rate, i.e., one of many possible parameters being monitored, may be 60 to 100 beats per minute). The “basic range” (or normal range) of statistical values is a range between the minimum and maximum values at which a particular system functions normally and without indication of a potential problem. Generally, the basic range is narrower than the acceptable range. The basic range may vary for different systems, but it must be determined for every system.

In accordance with one aspect of the present invention, there is provided a computer-readable medium having computer-executable components for converting data relating to a specific system, comprising: a data evaluation component which generates converted data information based on evaluation of data; a general report generating component which receives data information from the data evaluation component and expert information, and which generates general reports based on the expert information and the data information; a system-specific report generating component which receives information pertaining to the specific system and expert information, and which generates system-specific reports based on the expert information, the information pertaining to the specific system and data information received from the data evaluation component; and a decision-making component which makes decisions based on data information from the data evaluation component, the general reports and the system-specific reports.

Preferably, the data evaluation component, the general report generating component, the system-specific report generating component and the decision-making component are included on a single computer-readable medium (e.g., a computer-readable medium contained in a single computer or network), but alternatively, the data evaluation component, the general report generating component, the system-specific report generating component and the decision-making component can each be included on different computer-readable media, e.g., different computer-readable media on different computers, processors or devices, or can be included on one or more computer-readable media in any desired combinations (e.g., the data evaluation component and the general report generating component on a single computer-readable medium, the system-specific report generating component on a separate computer-readable medium and the decision-making component on a separate computer-readable medium).

Preferably, the data evaluation component, the general report generating component, the system-specific report generating component and the decision-making component are in the form of software stored on a computer-readable medium. Preferably, the general report generating component, the system-specific report generating component and the decision-making component are contained in a single software program, but alternatively, the data evaluation component, the general report generating component, the system-specific report generating component and the decision-making component can be contained in different software programs, or can be contained in one or more software programs in any desired combinations (e.g., the data evaluation component and the general report generating component on a single program, and the system-specific report generating component and the decision-making component on a separate program).

As noted above, the at least one sensor collects data relating to at least one parameter, respectively, of or relating to the system. The data evaluation component generates data information which includes analyses of the data in specific formats which are sent to the general report generating component, the system-specific report generating component and the decision-making component. The general report generating component generates general reports based on (1) expert information relating to the type of system being evaluated and (2) data information received from the data evaluation component. The system-specific report generating component generates system-specific reports based on (1) expert information relating to the type of system being evaluated and (2) data information received from the data evaluation component, and (3) information pertaining to the specific system (as opposed to the type of system) being evaluated. As a result, the system-specific reports may be shifted from the general reports, due to the fact that the system-specific reports factor in information pertaining to the specific system, as well as expert information relating to the type of system.

Each of the components described herein performs a useful function. Accordingly, the present invention is directed to not only the apparatuses described herein which comprise a data evaluation component; a general report generating component; a system-specific report generating component; and a decision-making component, but also to each of the individual components in such apparatuses, e.g., the invention is also directed to data evaluation components. Furthermore, the present invention is directed to each of the individual method steps carried out by these components, and to all combinations of such method steps, as well as means for performing each of these individual method steps, and all combinations of such means for performing these method steps.

As noted above, in one aspect of the present invention, the data evaluation component takes an initial set of data values, removes all data values which exceed a maximum possible value or which are below a minimum possible value, and preferably determines whether a significant number of the data values in the initial set are outside of an “acceptable” range. If a significant number of the data values in the initial set are within the acceptable range, the data evaluation component preferably generates a “basic record”, which identifies a basic range (preferably within the acceptable range and which preferably encompasses fewer values than the acceptable range) within which a significant number of the data values in the initial set fall. The basic record is thus a baseline for the specific system being analyzed, against which subsequent “current records” can be compared, to help to see whether the data reflects a trending away from the original condition of the system, and possible movement toward a changed circumstance (and possibly an emergency situation). The data evaluation component preferably receives subsequent sets of data values, and examines whether significant quantities of data values are in specific ranges defined outside of the basic range and/or outside of the acceptable range. By evaluating the quantity of data values in a variety of such ranges established by the data evaluation based on the data received, the data evaluation component selects different algorithms for generating data information in specific formats (examples of which are described in detail below), each format being useful in evaluating trends in the data values.

The general report generating component, the system-specific report generating component and the decision-making component each contain arrays and/or networks of logic. For example, where the system is a human patient being medically monitored, the general report generating component might include logic to the effect that when the patient is undergoing heart surgery, if the patient's blood pressure decreases, there is a high probability that the patient is going into or heading toward cardiogenic shock (which has a 95% mortality rate); or, where a patient is presenting with non-septic shock, if the patient shows a rapid SaO₂ decrease, there is a high probability that the patient is in anaphylactic shock, rather than neurogenic shock. Where particular parameters are related to a large number of different logic patterns (e.g., high blood pressure suggests increased probabilities of different conditions in a variety of respective circumstances), the networks of logic can be inter-related to a large degree.

Below is a discussion of a specific example of an embodiment according to this aspect of the present invention. In the discussion of this embodiment which follows, the data evaluation component which receives sensor data from the at least one sensor and which generates data information based on evaluation of the sensor data in the present embodiment is the “DataAgent”; the general report generating component in the present embodiment is the “GeneralNET”; the system-specific report generating component is the “PersonalNET”; and the decision-making component is the “ArbiterAgent”.

Preferably, DataAgent, GeneralNET, PersonalNET and ArbiterAgent are included on a single computer-readable medium (e.g., on a single computer or network), but alternatively, DataAgent, GeneralNET, PersonalNET and ArbiterAgent can each be included on different computer-readable media on different computers, processors or devices, or can be included on one or more computer-readable media on different computers, processors or other devices in any desired combinations (e.g., DataAgent and GeneralNET on a single computer-readable medium, PersonalNET on a separate computer-readable medium and ArbiterAgent on a separate computer-readable medium).

Preferably, DataAgent, GeneralNET, PersonalNET and ArbiterAgent are contained in a single software program, but alternatively, commands for the functioning of DataAgent, GeneralNET, PersonalNET and ArbiterAgent can be contained in different software programs, or can be contained in one or more software programs in any desired combinations (e.g., the commands for DataAgent and GeneralNET on a single program, and the commands for PersonalNET and ArbiterAgent on a separate program).

An example of an apparatus corresponding to this specific embodiment is an inference engine to support decision-making in an intensive care unit (ICU). The present invention covers a variety of embodiments in any field of use where data needs to be evaluated, and is limited neither to the field of medical analysis nor to the specific handling of data as described in connection with the specific embodiment described below.

The inference engine of this example according to this embodiment helps an ICU staff to respond quickly to critical situations, predicts emergencies (e.g., recognizes pre-shock conditions and requires a doctor's attention at an early stage), and/or generates alarms to require an action (while minimizing any false alarms). That is, based on data from sensors, the inference engine can indicate a patient's condition and report probabilities of having one or more common types of emergency conditions (e.g., shocks). If probabilities are high, then the system may require an alarm. Similarly, based on tendencies of changes in readings, the system can predict a possible emergency condition which can occur in the near future.

This embodiment includes the following components:
GeneralNET—a Bayesian network design which is based on expert information (e.g., medical knowledge);
PersonalNET—a Bayesian network design which is based on expert information, and which learns from incoming data;
DataAgent—evaluates tendencies and provides information in specific formats to GeneralNet, to PersonalNET and to ArbiterAgent; and
ArbiterAgent—makes decisions based on reports from GeneralNet, reports from PersonalNET, and information from DataAgent.

The inference engine of this example corresponding to this embodiment receives substantially real-time data from one or more sensors, general data consisting of basic information about normal values for monitoring statistics (for example, blood pressure or heart rate), and patient data comprising information about the patient's history, the patient's current condition, etc. Optionally, the inference engine may also receive manually entered data (this data component is optional, i.e., the system is able to make decisions when there is no manual data).

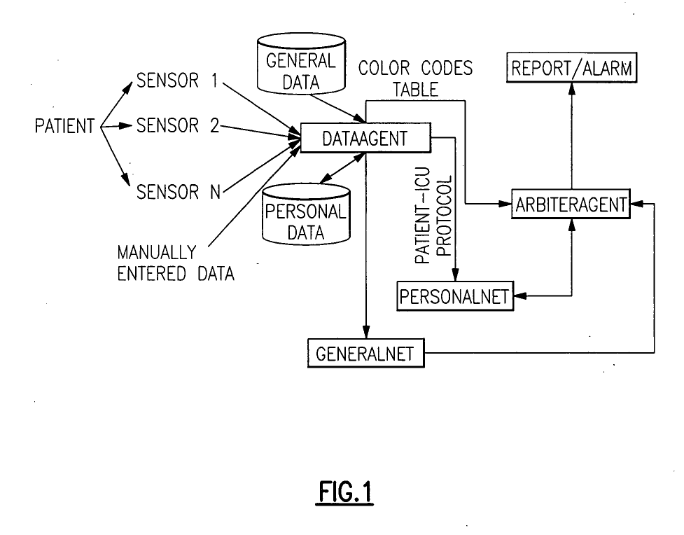

The structure of the inference engine according to this example corresponding to this embodiment is depicted in FIG. 1.

DataAgent receives information from one or more sensors, and/or from one or more data files, and places information in specific respective formats for receipt by GeneralNET, by PersonalNet and by ArbiterAgent.

DataAgent detects minor to severe increases or decreases of the incoming values from the one or more sensors and evaluates the data to model situations which can potentially occur. DataAgent interfaces with ArbiterAgent, GeneralNET and PersonalNET, the one or more sensors, a database with general information (referred to herein as “General Database”) such as acceptable ranges for many parameters (e.g., where the system is a patient, expert medical information), and a database with information regarding the particular system (referred to herein as “Personal Database”), e.g., where the system is a patient, medical information regarding the patient.

As discussed below in more detail, in this embodiment, DataAgent generates information in two types of modes, a real mode and a tendency mode.

In the real mode of this embodiment, DataAgent receives information from sensors, compares it with information in General Database and/or information in Personal Database, and generates a real mode record and a real mode output. In the real mode, the status is characterized as “normal” if a statistical value is within the acceptable range; the status is characterized as “high” if the statistical value is higher than the maximum value in the acceptable range; and the status is declared “low” if the statistical value is lower than the minimum value in the acceptable range.

In the tendency mode of this embodiment, DataAgent collects information from the sensors during a period of time (every T seconds) and compares it to basic records. Basic records, described below in more detail, function as baseline information for comparing later-obtained data. Based on such comparisons, DataAgent creates current records, decreasing current records and/or increasing current records (described below in more detail). If significant changes occur and a potential problem is detected, then DataAgent creates respective status records for each of GeneralNET and PersonalNET, and generates a status/color code record for ArbiterAgent.

In this embodiment, the tendency mode can be turned on or off, but the real mode is always on so that DataAgent always sends real data. The DataAgent processes data every T seconds.

The following discussion details analysis of data for a single parameter—other parameters for a system may be handled in an analogous way.

In this example according to this embodiment, when a new patient arrives at an ICU, as discussed below, in most cases (i.e., unless a significant number of data values for the parameter being monitored are and remain outside an acceptable range) a basic record is created with respect to the real-time data received from each of one or more sensors (e.g., where blood pressure, heart rate, temperature and CO sensors are each collecting data, a blood pressure basic record will be created, a heart rate basic record will be created, a temperature basic record will be created and a CO basic record will be created). Each of these records includes data set forth in a specific format, discussed in more detail below. In addition, a basic image may be created, which includes all of the basic records (e.g., where blood pressure, heart rate, temperature and CO sensors are each collecting data, the basic image includes the blood pressure basic record, the heart rate basic record, the temperature basic record and the CO basic record). The basic image includes its data set forth in a specific format, as discussed in more detail below. As discussed in more detail below, in specific circumstances (e.g., when the patient is no longer presenting with a particular symptom), the basic image (or one or more basic records) for the patient can be updated (i.e., replaced with a new basic image generated using current data).

In this example corresponding to this embodiment, a MIN/MAX/Low/High/Acceptable detection routine is performed for each parameter (e.g., medical parameters) being monitored and/or evaluated. The MIN/MAX/Low/High/Acceptable detection routine(s) are preferably performed when a patient first arrives at an ICU, but may instead be performed anytime thereafter. For each parameter being monitored or evaluated (e.g., heart rate, blood pressure, etc.), a set of data values is received from the sensor for that parameter. Each data value is the value of the parameter detected by the sensor during a sub-interval (e.g., one second) within an initial time interval (e.g., five minutes). Each sub-interval within the initial time interval is a period of time such that the sub-intervals taken together sequentially comprise an entirety of the initial time interval (e.g., 300 sequential one second sub-intervals within an initial time interval of five minutes).

Then, each of the data values (among the set of data values for this parameter) is assigned to one category selected from among categories characterized as “MIN”, “Low”, “Acceptable”, “High” and “MAX”. Each data value (i.e., if any) which is less than a minimum possible value is characterized as “MIN”. Each data value which is greater than a maximum possible value is characterized as “MAX”. Each data value which is within an acceptable range of values is characterized as “Acceptable”. Each data value which is greater than or equal to the minimum possible value and less than the lowest value in the acceptable range is characterized as “Low”. Each data value which is less than or equal to the maximum possible value and greater than the highest value in the acceptable range is characterized as “High”.

The effect of assigning data values less than a minimum possible value to “MIN” and assigning data values greater than a maximum possible value to “MAX” according to the present embodiment is to eliminate such readings because they are clearly erroneous (e.g., a negative heart rate or a heart rate which is larger than any possible human heart rate). This exclusion is done to eliminate data which is clearly incorrect, e.g., due to sensor error.

In accordance with a preferred aspect according to the present invention, if the quantity or percentage of data values (from among the set of data values) which are assigned to “MIN” (the “MIN value”) for the parameter exceeds a “replace sensor-min” value (e.g., 10% of the total quantity of signals), a signal is generated which indicates that the sensor which generated the readings for that parameter should be replaced. “Replace sensor-min” values may differ depending on the particular parameter. Similarly, in a preferred aspect, if the quantity or percentage of data values (from among the set of data values) which are assigned to “MAX” (the “MAX value”) for the parameter exceeds a “replace sensor-max” value, a signal is generated which indicates that the sensor which generated the readings for that parameter should be replaced. “Replace sensor-max” values also may differ depending on the particular parameter.

The acceptable range of values described above is defined as a range of values between and including a lowest acceptable value and a highest acceptable value. The lowest acceptable value is a reference value which is considered by experts in the appropriate field to be the minimum normally acceptable value, (e.g., in the case of heart rate, 60 beats per minute). The highest acceptable value is a reference value which is considered by experts to be the maximum normally acceptable value, (e.g., in the case of heart rate, 100 beats per minute).

Next, a determination is made as to whether either of the categories “Low” and “High” has the most data values. If “Low” has more data values than each of “Acceptable” and “High”, a color code indicator is characterized as “red”, a status indicator is characterized as “decreasing”, and another MIN/MAX/Low/High/Acceptable detection routine is then performed.

If “High” has at least as many data values as “Low”, and more data values than “Acceptable”, the color code indicator is characterized as “red”, the status indicator is characterized as “increasing” and another MIN/MAX/Low/High/Acceptable detection routine is then performed.

Otherwise (i.e., unless “Low” has more data values than each of “High” and “Acceptable”, or “High” has more data values than “Acceptable” and at least as many data values as “Low”), a basic record creation routine is then performed. In the basic record creation routine, the range of values within the “Acceptable” category for the parameter is divided into a number (e.g., 30, 40 or 60) of range segments. Preferably, the range segments each cover ranges of substantially equal size—for example, if the parameter is heart rate and acceptable values are within the range of from 60 to 100 (beats per minute), and the number of range segments is 41, each range segment covers a range of one value (i.e., 60, 61, 62, 63, etc.); if the parameter is blood pressure and acceptable values are within the range of from 100 to 120, and the number of range segments is 40, each range segment covers a range of about 0.5 (e.g., 100.0 to 100.5, 100.6 to 101.0, 101.1 to 101.5, etc.). Then, for each of the range segments, a quantity of the data values which fall within the range segment is determined. Then a range segment having a maximum quantity of the data values is identified and characterized as Rmax. Rmax is assigned to a final range category. Then, a next range segment analysis is performed.

In a next range segment analysis, a next lower range segment is the range segment having values just below the lowest value within the final range, and a next higher range segment is the range segment having values just above the highest value in the final range (if all range segments have already been included in the final range, the next range segment analysis is concluded and, as described below, a final range comparison is performed next). If the next lower range segment has a greater quantity of data values than the quantity of data values in the next higher range segment (or if there are no remaining range segments having values higher than the final range), a determination is made as to whether the next lower range segment has a quantity of data values which is at least a minimum ratio (e.g., 0.7 or any other desired ratio) of the quantity of data values in Rmax; if so, the next lower range segment is added to the final range category and another next range segment analysis is performed next. If the next lower range segment does not have a greater quantity of data values than the quantity of data values in the next higher range segment (or if there are no remaining range segments having values lower than the final range), a determination is made as to whether the next higher range segment has a quantity of data values which is at least the minimum ratio of the quantity of data values in Rmax; if so, the next higher range segment is added to the final range category and another next range segment analysis is performed next.

If the next lower range segment and the next higher range segment each have a quantity of data values which is less than the minimum ratio of the quantity of data values in Rmax, or if there is no next lower range segment and the next higher range segment has a quantity of data values which is less than the minimum ratio of the quantity of data values in Rmax, or if there is no next higher range segment and the next lower range segment has a quantity of data values which is less than the minimum ratio of the quantity of data values in Rmax, or if all range segments have already been included in the final range, a final range comparison routine is then performed.

In the final range comparison routine, a determination is made as to which of the range segments have a quantity of data values which is at least the minimum ratio of the quantity of data values in Rmax. Then a determination is made as to whether every range segment which has a quantity of data values which is at least the minimum ratio of the quantity of data values in Rmax is included in the final range. If not, the number of range segments is decreased by one and another basic record creation routine is performed next.

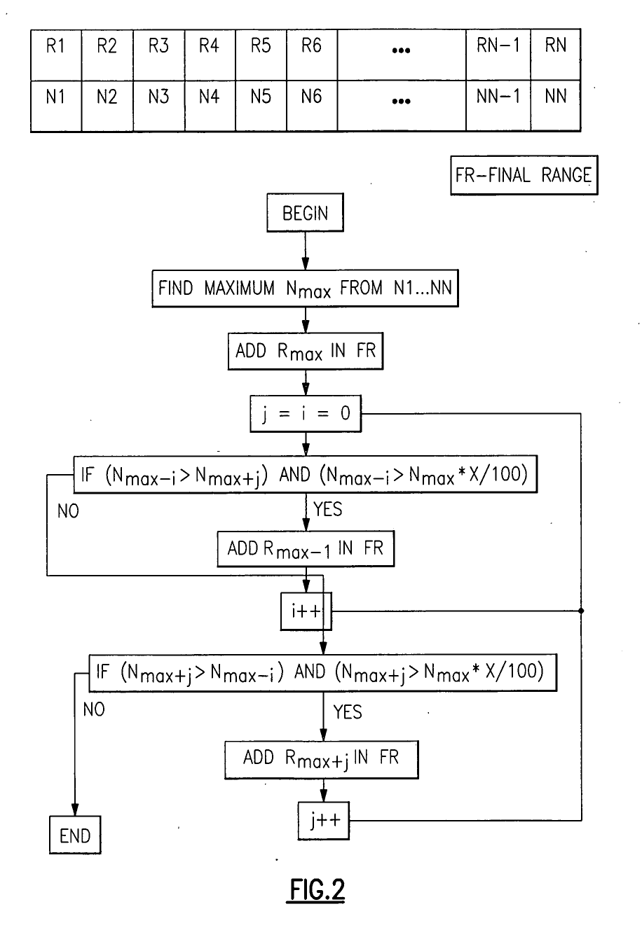

An example of an embodiment of an algorithm for determining the segments included in the “final range” is depicted in FIG. 2.

If every range segment which has a quantity of data values which is at least the minimum ratio of the quantity of data values in Rmax is included in the final range, a determination is made as to the quantity of data values (from among the set of data values) falling within a Low range (the “Low value”), the quantity of data values falling within an X range (the “X value”), the quantity of data values falling within a Y range (the “Y value”), the quantity of data values falling within a Z range (the “Z value”) and the quantity of data values falling within a High range (the “High value”). The Low range includes all values which are not less than the minimum possible value and which are less than the lowest value in the acceptable range. The X range includes all values which are not less than the lowest value in the acceptable range and which are less than the lowest value in the final range. The Y range includes all values which are within the final range. The Z range includes all values which are greater than the highest value in the final range and which are not greater than the highest value in the acceptable range. The High range includes all values which are not greater than the maximum possible value and which are greater than the highest value in the acceptable range.

Optionally, in addition, a determination may be made as to the quantity of data values assigned to the “MIN” category (the MIN value) and the quantity of data values assigned to the “MAX” category (the MAX value).

For each set of data values relating to a specific parameter, a basic record is created. Each basic record contains the following components:
the parameter's name (e.g., heart rate) or identifier (e.g., a code or ID number);
the “P-time”, i.e., the period of time, in seconds, between each time that the parameter is to be detected (preferably, the P-time is input by the user);
the “T-time”, i.e., the period of time, in seconds, during which values are to be monitored to generate a “current record” (current records are described in detail below);
the Low value;
the X value;
the Y value;
the Z value; and
the High value.

Optionally, the basic record may also include:
the MIN value; and
the MAX value.

A similar basic record is created for each other parameter being detected. The basic records for the different parameters together make up a basic image.

After creating a basic record for a parameter, next, a current record creation routine is performed for that parameter. In the current record creation routine, a fresh set of data values for the parameter is received from the sensor for that parameter. As above, the following discussion focuses on the analysis of data for a single parameter—each of the other parameters can be handled in an analogous way. Each data value among the fresh set of data values is the value of the parameter detected by the sensor during a sub-interval (e.g., one second) within a current time interval (e.g., one minute). Each current time interval preferably follows immediately after the end of the previous time interval (i.e., immediately after a previous current time interval or, where there have been no previous current time intervals, immediately after the initial time interval). Each sub-interval within a current time interval is a period of time such that the sub-intervals taken together sequentially comprise an entirety of the current time interval (e.g., 60 sequential one second sub-intervals within a current time interval of one minute).

Then, a Low value, an X value, a Y value, a Z value and a High value are determined. The Low value is the quantity of data values within the fresh set of data values which fall within the Low range. The X value is the quantity of data values within the fresh set of data values which fall within the X range. The Y value is the quantity of data values within the fresh set of data values which fall within the Y range. The Z value is the quantity of data values within the fresh set of data values which fall within the Z range. The High value is the quantity of data values within the fresh set of data values which fall within the High range.

Optionally, in addition, a determination may be made as to the quantity of data values assigned to the “MIN” category (the MIN value) and the quantity of data values assigned to the “MAX” category (the MAX value).

If the Low value is greater than each of the X value, the Y value, the Z value and the High value, the color code indicator is characterized as “red”, the status indicator is characterized as “decreasing” and a decreasing current record creation routine (described below) is then performed.

If the High value is greater than or equal to the Low value, and is greater than each of the X value, the Y value and the Z value, the color code indicator is characterized as “red”, the status indicator is characterized as “increasing” and an increasing current record creation routine (described below) is then performed.

If the X value is greater than or equal to the Low value and greater than or equal to the High value, and is greater than each of the Y value and the Z value, the color code indicator is characterized as “yellow”, the status indicator is characterized as “decreasing” and a decreasing current record creation routine is then performed.

If the Z value is greater than or equal to the Low value, greater than or equal to the X value, greater than or equal to the High value, and greater than the Y value, the color code indicator is characterized as “yellow”, the status indicator is characterized as “increasing” and an increasing current record creation routine is then performed.

If the Y value is greater than or equal to the Low value, greater than or equal to the X value, greater than or equal to the Z value and greater than or equal to the High value, the color code indicator is characterized as “green”, the status indicator is characterized as “normal” and another current record creation routine is performed next.

For each fresh set of data values relating to a specific parameter, a current record is created. Each current record contains the following components:
the parameter's name or identifier;
the Low value;
the X value;
the Y value;
the Z value; and
the High value.

Optionally, the current record may also include:
the status indicator, i.e., “increasing”, “decreasing” or “normal” (or corresponding symbols, e.g., “1” for “increasing”, “2” for “decreasing” and “0” for “normal”); and
the color code indicator, i.e., “red”, “orange”, “yellow” or “green” (or corresponding symbols, e.g., “0” for “green”, “1” for “yellow”, “2” for “orange” and “3” for “red”).

Optionally, the current record may also include:
the MIN value; and
the MAX value.

In performing a decreasing current record creation routine (referred to above), a new fresh set of data values for the parameter is received from the sensor for that parameter. As above, the following discussion focuses on the analysis of data for a single parameter—each of the other parameters can be handled in an analogous way. Each data value among the new fresh set of data values is the value of the parameter detected by the sensor during a sub-interval (e.g., one second) within a current time interval (e.g., one minute). Each current time interval preferably follows immediately after the end of the previous current time interval. Each sub-interval within a current time interval is a period of time such that the sub-intervals taken together sequentially comprise an entirety of the current time interval (e.g., 60 sequential one second sub-intervals within a current time interval of one minute).

Then, a new Low value, an X1 value, an X2 value, an X3 value, a new Y value, a new Z value and a new High value are determined. The new Low value is the quantity of data values within the new fresh set of data values which fall within the Low range. The X1 value is the quantity of data values within the new fresh set of data values which fall within a first portion of the X range. The X2 value is the quantity of data values within the new fresh set of data values which fall within a second portion of the X range, the second portion of the X range including values which are greater than values in the first portion of the X range. The X3 value is the quantity of data values within the new fresh set of data values which fall within a third portion of the X range, the third portion of the X range including values which are greater than values in the second portion of the X range. In a preferred representative example, the third portion of the X range is the highest approximately 50% of the values within the X range, the first portion of the X range is the lowest approximately 30% of the values within the X range, and the second portion of the X range is the remaining approximately 20% of the values within the X range. The new Y value is the quantity of data values within the new fresh set of data values which fall within the Y range. The new Z value is the quantity of data values within the new fresh set of data values which fall within the Z range. The new High value is the quantity of data values within the new fresh set of data values which fall within the High range.

Optionally, in addition, a determination may be made as to the quantity of data values in the new fresh set of data values assigned to the “MIN” category (the MIN value) and the quantity of data values in the new fresh set of data values assigned to the “MAX” category (the MAX value).

Then, if the new High value is greater than each of the new Low value, the X1 value, the X2 value, the X3 value, the new Y value and the new Z value, the color code indicator is characterized as “red”, the status indicator is characterized as “increasing” and an increasing current record creation routine is performed next.

If the new Low value is greater than or equal to the new High value, and is greater than each of the X1 value, the X2 value, the X3 value, the new Y value and the new Z value, the color code indicator is characterized as “red”, the status indicator is characterized as “decreasing” and another decreasing current record creation routine is performed next.

If the new Z value is greater than or equal to the new High value and greater than or equal to the new Low value, and is greater than each of the X1 value, the X2 value, the X3 value and the new Y value, the color code indicator is characterized as “yellow”, the status indicator is characterized as “increasing” and an increasing current record creation routine is performed next.

If the X1 value is greater than or equal to the new Low value, greater than or equal to the new High value and greater than or equal to the new Z value, and is greater than each of the X2 value, the X3 value and the new Y value, the color code indicator is characterized as “orange”, the status indicator is characterized as “decreasing” and another decreasing current record creation routine is performed next.

If the X2 value is greater than or equal to the new Low value, greater than or equal to the new High value, greater than or equal to the new Z value and greater than or equal to the X1 value, and is greater than each of the X3 value and the new Y value, the color code indicator is characterized as “yellow”, the status indicator is characterized as “decreasing” and another decreasing current record creation routine is performed next.

If the X3 value is greater than or equal to the new Low value, greater than or equal to the new High value, greater than or equal to the new Z value, greater than or equal to the X1 value, greater than or equal to the X2 value, and greater than the new Y value, the color code indicator is characterized as “yellow”, the status indicator is characterized as “decreasing” and another decreasing current record creation routine is performed next.

If the new Y value is greater than or equal to the new Low value, greater than or equal to the X1 value, greater than or equal to the X2 value, greater than or equal to the X3 value, greater than or equal to the new Z value and greater than or equal to the new High value, the color code indicator is characterized as “green”, the status indicator is characterized as “normal” and another current record creation routine is performed next.

For each new fresh set of data values relating to a specific parameter, a decreasing current record is created. Each decreasing current record contains the following components:
the parameter's name (e.g., heart rate) or identifier (e.g., a code or ID number);
the new Low value;
the X1 value;
the X2 value;
the X3 value;
the new Y value;
the new Z value; and
the new High value.

Optionally, the decreasing current record may also include:
the status indicator, i.e., “increasing”, “decreasing” or “normal” (or corresponding symbols, e.g., “1” for “increasing, “2” for “decreasing” and “0” for “normal”); and
the color code indicator, i.e., “red”, “orange”, “yellow” or “green” (or corresponding symbols, e.g., “0” for “green”, “1” for “yellow”, “2” for “orange” and “3” for “red”).

Optionally, the decreasing current record may also include:
the new MIN value; and
the new MAX value.

In performing an increasing current record creation routine (referred to above), a current fresh set of data values for the parameter is received from the sensor for that parameter. As above, the following discussion focuses on the analysis of data for a single parameter—each of the other parameters can be handled in an analogous way. Each data value among the current fresh set of data values is the value of the parameter detected by the sensor during a sub-interval (e.g., one second) within a current time interval (e.g., one minute). Each current time interval preferably follows immediately after the end of the previous current time interval. Each sub-interval within a current time interval is a period of time such that the sub-intervals taken together sequentially comprise an entirety of the current time interval (e.g., 60 sequential one second sub-intervals within a current time interval of one minute).

Then, a current Low value, a current X value, a current Y value, a Z1 value, a Z2 value, a Z3 value and a current High value are determined. The current Low value is the quantity of data values within the current fresh set of data values which fall within the Low range. The current X value is the quantity of data values within the current fresh set of data values which fall within the X range. The current Y value is the quantity of data values within the current fresh set of data values which fall within the Y range. The Z1 value is the quantity of data values within the current fresh set of data values which fall within a first portion of the Z range. The Z2 value is the quantity of data values within the current fresh set of data values which fall within a second portion of the Z range, the second portion of the Z range including values which are greater than values in the first portion of the Z range. The Z3 value is the quantity of data values within the current fresh set of data values which fall within a third portion of the Z range, the third portion of the Z range including values which are greater than values in the second portion of the Z range. In a preferred representative example, the first portion of the Z range is the lowest approximately 50% of the values within the Z range, the third portion of the Z range is the highest approximately 30% of the values within the Z range, and the second portion of the Z range is the remaining approximately 20% of the values within the Z range. The current High value is the quantity of data values within the current fresh set of data values which fall within the High range.

Optionally, in addition, a determination may be made as to the quantity of data values assigned to the “MIN” category (the MIN value) and the quantity of data values assigned to the “MAX” category (the MAX value).

Then, if the current Low value is greater than each of the current X value, the current Y value, the Z1 value, the Z2 value, the Z3 value and the current High value, the color code indicator is characterized as “red”, the status indicator is characterized as “decreasing” and a decreasing current record creation routine is performed next.

If the current High value is greater than or equal to the current Low value, and is greater than each of the current X value, the current Y value, the Z1 value, the Z2 value and the Z3 value, the color code indicator is characterized as “red”, the status indicator is characterized as “increasing” and another increasing current record creation routine is performed next.

If the current X value is greater than or equal to the current Low value and greater than or equal to the current High value, and is greater than each of the current Y value, the Z1 value, the Z2 value and the Z3 value, the color code indicator is characterized as “yellow”, the status indicator is characterized as “decreasing” and a decreasing current record creation routine is performed next.

If the Z3 value is greater than or equal to the current Low value, greater than or equal to the current High value and greater than or equal to the current X value, and is greater than each of the current Y value, the Z1 value and the Z2 value, the color code indicator is characterized as “orange”, the status indicator is characterized as “increasing” and another increasing current record creation routine is performed next.

If the Z2 value is greater than or equal to the current Low value, greater than or equal to the current High value, greater than or equal to the current X value and greater than or equal to the Z3 value, and is greater than each of the current Y value and the Z1 value, the color code indicator is characterized as “yellow”, the status indicator is characterized as “increasing” and another increasing current record creation routine is performed next.

If the Z1 value is greater than or equal to the current Low value, greater than or equal to the current High value, greater than or equal to the current X value, greater than or equal to the Z3 value, greater than or equal to the Z2 value, and greater than the current Y value, the color code indicator is characterized as “yellow”, the status indicator is characterized as “increasing” and another increasing current record creation routine is performed next.

If the current Y value is greater than or equal to the current Low value, greater than or equal to the current X value, greater than or equal to the Z1 value, greater than or equal to the Z2 value, greater than or equal to the Z3 value and greater than or equal to the current High value, the color code indicator is characterized as “green”, the status indicator is characterized as “normal” and another current record creation routine is performed next.

For each current fresh set of data values relating to a specific parameter, an increasing current record is created. Each increasing current record contains the following components:
the parameter's name (e.g., heart rate) or identifier (e.g., a code or ID number);
the current Low value;
the current X value;
the current Y value;
the Z1 value;
the Z2 value;
the Z3 value; and
the current High value.

Optionally, the increasing current record may also include:
the status indicator, i.e., “increasing”, “decreasing” or “normal” (or corresponding symbols, e.g., “1” for “increasing, “2” for “decreasing” and “0” for “normal”); and
the color code indicator, i.e., “red”, “orange”, “yellow” or “green” (or corresponding symbols, e.g., “0” for “green”, “1” for “yellow”, “2” for “orange” and “3” for “red”).

Optionally, the increasing record may also include:
the MIN value; and
the MAX value.

In the above discussion of this embodiment, various choices have been made regarding how the embodiment proceeds in the event that two or more values are equal (e.g., in the event that the X value and the Z value are equal, according to the discussion of the embodiment set forth above, the Z value controls, i.e., the status indicator is characterized as “increasing” and an increasing current record creation routine is performed next). However, in accordance with the present invention, the hierarchy as to which value controls in situations where any two or more values are equal can be set up in any other way (e.g., in the event that the X value and the Z value are equal, the X value can control, i.e., such that the status indicator would be characterized as “decreasing” and a decreasing current record creation routine would be performed next).

In accordance with the present embodiment, it is not necessary that any or all types of current records (i.e., including “current records”, “decreasing current records” and “increasing current records”) be retained after real mode output and optionally also tendency mode output (discussed in more detail below) are sent to the ArbiterAgent, the PersonalNET and the GeneralNET. For example, upon initiating a next routine, the previous current record, decreasing current record or increasing current record can optionally be discarded.

The current records, increasing current records and decreasing current records for all the different parameters being monitored or evaluated together make up a current image.

Below is a discussion of a second specific example of an embodiment according to this aspect of the present invention, this second example being referred to below as the second embodiment.

The second embodiment is similar to the first embodiment described above, except that:
in the decreasing current record creation routine of the second embodiment:
   if the X1 value is greater than or equal to the new Low value, greater than or equal to the new High value and greater than or equal to the new Z value, and is greater than each of the X3 value, the X2 value and the new Y value, (1) the status indicator is characterized as “decreasing”, (2) the third portion of the X range is increased to include all values which were within the second portion of the X range as well as all values which were within the third portion of the X range, (3) the first portion of the X range is divided into a first part and a second part, the first part having values lower than the second part, the first part becoming the first portion of the X range, the second part becoming the second portion of the X range, and (4) another decreasing current record creation routine is performed next;
   if the X2 value is greater than or equal to the new Low value, greater than or equal to the new High value, and greater than or equal to the new Z value and the X1 value, and is greater than each of the X3 value and the new Y value, (1) the status indicator is characterized as “decreasing”, (2) the third portion of the X range is increased to include all values which were within the second portion of the X range as well as all values which were within the third portion of the X range, (3) the first portion of the X range is divided into a first part and a second part, the first part having values lower than the second part, the first part becoming the first portion of the X range, the second part becoming the second portion of the X range, and (4) another decreasing current record creation routine is performed next;
   if the X3 value is greater than or equal to the new Low value, greater than or equal to the new High value, greater than or equal to the X2 value, greater than or equal to the X1 value, greater than or equal to the new Z value, and greater than the new Y value, (1) the status indicator is characterized as “decreasing”, (2) the first portion of the X range is increased to include all values which were within the second portion of the X range as well as all values which were within the first portion of the X range, (3) the third portion of the X range is divided into a first part and a second part, the first part having values lower than the second part, the first part becoming the second portion of the X range, the second part becoming the third portion of the X range, and (4) another decreasing current record creation routine is performed next;
and, in the increasing current record creation routine of the second embodiment:
   if the Z3 value is greater than or equal to the current Low value, greater than or equal to the current High value and greater than or equal to the current X value, and is greater than each of the current Y value, the Z1 value and the Z2 value, (1) the status indicator is characterized as “increasing”, (2) the first portion of the Z range is increased to include all values which were within the second portion of the Z range as well as all values which were within the first portion of the Z range, (3) the third portion of the Z range is divided into a first part and a second part, the first part having values lower than the second part, the first part becoming the second portion of the Z range, the second part becoming the third portion of the Z range, and (4) another increasing current record creation routine is performed next;
   if the Z2 value is greater than or equal to the current Low value, greater than or equal to the current High value, greater than or equal to the current X value and greater than or equal to the Z3 value, and is greater than each of the current Y value and the Z1 value, (1) the status indicator is characterized as “increasing”, (2) the first portion of the Z range is increased to include all values which were within the second portion of the Z range as well as all values which were within the first portion of the Z range, (3) the third portion of the Z range is divided into a first part and a second part, the first part having values lower than the second part, the first part becoming the second portion of the Z range, the second part becoming the third portion of the Z range, and (4) another increasing current record creation routine is performed next; and
   if the Z1 value is greater than or equal to the current Low value, greater than or equal to the current High value, greater than or equal to the Z2 value, greater than or equal to the Z3 value, greater than or equal to the current X value, and greater than the current Y value, (1) the status indicator is characterized as “increasing”, (2) the third portion of the Z range is increased to include all values which were within the second portion of the Z range as well as all values which were within the third portion of the Z range, (3) the first portion of the Z range is divided into a first part and a second part, the first part having values lower than the second part, the first part becoming the first portion of the Z range, the second part becoming the second portion of the Z range, and (4) another increasing current record creation routine is performed next.

In the second embodiment as described above:
in the decreasing current record creation routine, the color code indicator is preferably characterized in other situations, i.e., including:
   when the X1 value is greater than or equal to the new Low value, greater than or equal to the new High value and greater than or equal to the new Z value, and is greater than each of the X3 value, the X2 value and the new Y value,
   when the X2 value is greater than or equal to the new Low value, greater than or equal to the new High value, and greater than or equal to the new Z value and the X1 value, and is greater than each of the X3 value and the new Y value, and
   when the X3 value is greater than or equal to the new Low value, greater than or equal to the new High value, greater than or equal to the X2 value, greater than or equal to the X1 value, greater than or equal to the new Z value, and greater than the new Y value; and
based on the new fresh set of data values, and
in the increasing current record creation routine, the color code indicator is preferably characterized in other situations, i.e., including:
   when the Z3 value is greater than or equal to the current Low value, greater than or equal to the current High value and greater than or equal to the current X value, and is greater than each of the current Y value, the Z1 value and the Z2 value,
   when the Z2 value is greater than or equal to the current Low value, greater than or equal to the current High value, greater than or equal to the current X value and greater than or equal to the Z3 value, and is greater than each of the current Y value and the Z1 value, and
   when the Z1 value is greater than or equal to the current Low value, greater than or equal to the current High value, greater than or equal to the Z2 value, greater than or equal to the Z3 value, greater than or equal to the current X value, and greater than the current Y value,
      based on the current fresh set of data values.

For example, in one preferred aspect of the second embodiment:
during a decreasing current record creation routine, the color code indicator is characterized based on the new fresh set of data values by further:
   determining a new X value, the new X value being a quantity of data values within the new fresh set of data values which fall within the X range; and
   then, after characterizing the status indicator in the decreasing current record creation routine being performed:
      if the status indicator is characterized as “decreasing” and the new X value is greater than the new Low value, the new Y value, the new Z value and the new High value, characterizing the color code indicator as “yellow”, and
      if the status indicator is characterized as “increasing” and the new Z value is greater than the new Low value, the new X value, the new Y value and the new High value, characterizing the color code indicator as “yellow”; and
during an increasing current record creation routine, the color code indicator is characterized based on the current fresh set of data values by further:
   determining a component Z value, the component Z value being a quantity of data values within the component fresh set of data values which fall within the Z range; and
   then, after characterizing the status indicator in the increasing current record creation routine being performed:
      if the status indicator is characterized as “decreasing” and the component X value is greater than the component Low value, the component Y value, the component Z value and the component High value, characterizing the color code indicator as “yellow”, and
      if the status indicator is characterized as “increasing” and the component Z value is greater than the component Low value, the component X value, the component Y value and the component High value, characterizing the color code indicator as “yellow”.

In a second preferred aspect of the second embodiment,
during a decreasing current record creation routine, the color code indicator is characterized based on the new fresh set of data values by further:
   after determining a new Low value, an X1 value, an X2 value, an X3 value, a new Y value, a new Z value and a new High value,
   if the X3 value is greater than the new Low value, the X1 value, the X2 value, the new Y value, the new Z value and the new High value, characterizing the color code indicator as “yellow”;
   if the X2 value is greater than the new Low value, the X1 value, the new Y value, the new Z value and the new High value, and is not less than the X3 value, characterizing the color code indicator as “yellow”;
   if the X1 value is greater than the new Low value, the new Y value, the new Z value and the new High value, and is not less than the X2 value and the X3 value, characterizing the color code indicator as “orange”; and
during an increasing current record creation routine, the color code indicator is characterized based on the current fresh set of data values by further:
   after determining a current Low value, a current X value, a current Y value, a Z1 value, a Z2 value, a Z3 value and a current High value,
   if the Z1 value is greater than the current Low value, the current X value, the current Y value, the Z2 value, the Z3 value and the current High value, characterizing the color code indicator as “yellow”;
   if the Z2 value is greater than the current Low value, the current X value, the current Y value, the Z3 value and the current High value, and is not less than the Z1 value, characterizing the color code indicator as “yellow”;
   if the Z3 value is greater than the current Low value, the current X value, the current Y value and the current High value, and is not less than the Z1 value and the Z2 value, characterizing the color code indicator as “orange”.

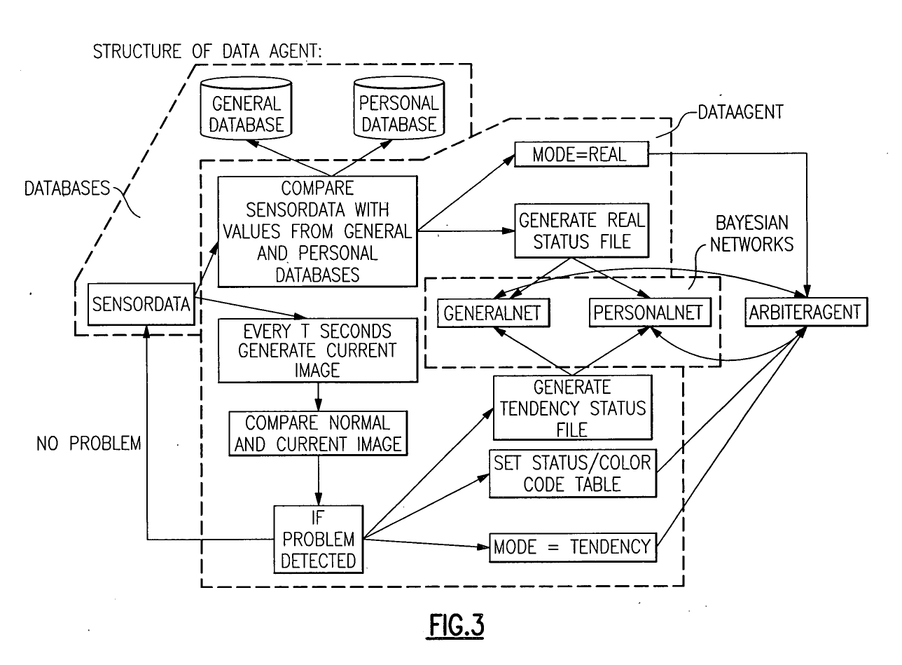

The architecture of DataAgent according to the embodiments described above is depicted in FIG. 3

In accordance with a preferred aspect of the present invention, DataAgent provides the option of automatically updating the basic record for a particular parameter when the color code indicator for that parameter has been yellow for a particular number of consecutive times (e.g., 30 times), which number may vary depending on the particular parameter, and/or when the color code indicator for that parameter has been orange for a particular number of consecutive times (which number may vary depending on the particular parameter). In addition, the number of consecutive times which prompts the basic record to be updated can differ depending on whether the yellow or orange color code is caused by elevated values (i.e., where the status indicator is “increasing”) or depressed values (i.e., where the status indicator is “decreasing”). In order to update the basic record, the basic record creation sub-routine is performed using fresh data from the sensor or sensors.

In accordance with a further preferred aspect of the present invention, DataAgent provides the option of automatically updating the basic record for a particular parameter when the values for that parameter have been within a range of a particular size (i.e., in which the highest value differs from the lowest value by not more than a particular amount), such that the basic range (and/or the acceptable range) can be modified so as to encompass such values. For example, even if the values have been consistently of quantities at which the color code is red, the basic range can be modified so as to encompass such values. Thus, where the acceptable range for heart rate is from 60 to 100 beats per minute, and the patient values have consistently been about 103, the acceptable range and the basic range for the heart rate parameter for the patient can be set such that they encompass 103 beats per minute.

Preferably, in addition, for each new fresh set of data values and for each current fresh set of data values (i.e., whenever a decreasing current record or an increasing current record is created), DataAgent also creates a temporary record.

For each new fresh set of data values, i.e., when DataAgent is performing a decreasing current record creation routine, the temporary record which is created is a decreasing temporary record. A decreasing temporary record includes the parameter's name (e.g., heart rate) or identifier (e.g., a code or ID number), an N value, the X1 value, the X2 value, the X3 value and a C value. The X1 value, the X2 value and the X3 value are the same as those described above in connection with the decreasing current record creation routine. In a decreasing temporary record, the N value is equal to the new Low value determined in the decreasing current record creation routine. In a decreasing temporary record, the C value is equal to the sum of the new Y value, the new Z value and the new High value determined in the decreasing current record creation routine.

For each current fresh set of data values, i.e., when DataAgent is performing an increasing current record creation routine, the temporary record which is created is an increasing temporary record. An increasing temporary record includes the parameter's name (e.g., heart rate) or identifier (e.g., a code or ID number), an N value, the Z1 value, the Z2 value, the Z3 value and a C value. The Z1 value, the Z2 value and the Z3 value are the same as those described above in connection with the increasing current record creation routine. In an increasing temporary record, the N value is equal to the sum of the new Low value, the new X value and the new Y value determined in the increasing current record creation routine. In an increasing temporary record, the C value is equal to the new High value determined in the increasing current record creation routine.

Upon returning to a green color code, preferably, any and all temporary records are discarded.

In each of the embodiments described above, for each current record, each decreasing current record and each increasing current record, DataAgent also generates a real mode record. The real mode record for a particular parameter includes a reading (“high”, “normal” or “low”, and/or an identifier which signifies one of such readings, e.g., 0 for normal, 1 for high or increased and 2 for low or decreased), a color code, as well as the parameter's name (e.g., heart rate) or identifier (e.g., a code or ID number). If the color code indicator for a parameter is red and the status is “increasing”, the parameter is given a “high” reading, and the color code is red. If the color code for the parameter is red and the status is “decreasing”, the parameter is given a “low” reading, and the color code is red. Otherwise (i.e., if the color code indicator is green, yellow or orange), the parameter is given a “normal” reading, and the color code is green. The real mode record is sent to ArbiterAgent, preferably along with a mode value indicating that it is a real mode record.

In addition, DataAgent preferably also generates a real mode output which is preferably sent to PersonalNET and GeneralNET, the real mode output preferably including the parameter's name (e.g., heart rate) or identifier and the reading (“high”, “low” or “normal”-determined in the same way as described above with regard to the real mode record).

In each of the embodiments described above, for each current record, each decreasing current record and each increasing current record, DataAgent preferably also generates a status/color code record. The status/color code record for a particular parameter preferably includes a status value (“increasing”, “decreasing” or “normal”), as well as the color code indicator (green, yellow, orange or red) and the parameter's name (e.g., heart rate) or identifier.

The status/color code record is sent to ArbiterAgent (preferably along with a tendency mode value indicating that it is a tendency mode reading).

In addition, one or more status records are preferably generated, which are preferably sent to GeneralNET and to PersonalNET. Preferably, a first status record includes (1) the parameter's name or identifier, and (2) a reading of “normal” if the color code indicator is green or yellow, a reading of “high” if the color code indicator is orange or red and the status is “increasing”, or a reading of “low” if the color code indicator is orange or red and the status is “decreasing”. The first status record is preferably used by GeneralNET and by PersonalNET to generate “orange” reports. Preferably, a second status record includes (1) the parameter's name or identifier, and (2) a reading of “normal” if the color code indicator is green, a reading of “high” if the color code indicator is yellow, orange or red and the status is “increasing”, or a reading of “low” if the color code indicator is yellow, orange or red and the status is “decreasing”. The second status record is preferably used by GeneralNET and by PersonalNET to generate “yellow” reports.

The color codes can be interpreted as follows:
Green—normal mode: values are real (the data is not from tendency mode) and they are in a normal range;
Yellow—values have changed, but the changes are minor and values are within acceptable ranges.
Orange—values have increased or decreased more severely. DataAgent detects a potentially severe problem, but values are still within an acceptable range.
Red—abnormal mode. The value is real so the data is not in tendency mode, and the value is outside of the acceptable range.

In accordance with a preferred aspect of the present invention, a tracking record can optionally be produced. A tracking record can include information as to the sequence of the ranges over time which had the maximum quantity of data values. For example, a tracking record might read “Y range, Y range, Y range, Y range, Z range, Z range, Z range, Z range, Z1 range, Z2 range, Z2 range, Z2 range, Z2 range, Z2 range, Z2 range, Z2 range, Z1 range, Z1 range, Z1 range, Z2 range, Z2 range, Z2 range, Z3 range, Z3 range, Z3 range, High range, High range, High range, Z3 range, Z3 range, Z2 range, Z2 range, Z1 range, Z1 range, Y range, Y range, Y range, Y range, Y range, Y range, Y range, Y range, Y range, Y range, etc.” Alternatively or additionally, the tracking record (or records) can include any other information, e.g., the quantity of data values in the range which had the maximum quantity of data values, and/or the quantity of data values in any other or all of the ranges.

The GeneralNET component of the inference engine according to the embodiments described above is designed based on experts' knowledge of the system being evaluated or monitored. For example, where the system is a human whose medical condition is being monitored, expert data can include information based on knowledge from the medical domain and preferably the use of a Bayesian network frame. Input to GeneralNET can be in the form of expert data contained in a case file or a separate formatted case. GeneralNET receives and evaluates the expert data, as well as real mode outputs and status records generated by DataAgent to generate expert reports, which show probabilities of a number of possible emergency conditions. For example, GeneralNET might recognize a pattern, e.g., of particular readings going up while other readings are going down, which is characteristic of one or more specific problems, and generate a probability as to whether that problem or problems exist. GeneralNET sends the expert reports to ArbiterAgent.

In the case where GeneralNET is in the form of a Bayesian network, the Bayesian network is set up in any suitable format, a variety of which are well known to those of skill in the art. For example, in accordance with one format, each parameter or condition has associated with it a table of values, and the table can further include one or more columns which each indicate whether a particular condition exists, and a plurality of probability columns. Each row of each probability column indicates the probability that the parameter or condition to which the table applies will fall within a corresponding range (for example, the ranges can include “high”, “normal”, and “low”) for that column when the condition or each of the conditions in that row are either present or not present as indicated by the responses in the respective columns. For example, a representative table is shown below for a parameter:

Parameter Name

| HIGH | NORMAL | LOW | CONDITION X | CONDITION Y |
|---|---|---|---|---|
| 0.05 | 0.05 | 0.90 | Yes | No |
| 0.09 | 0.02 | 0.89 | Yes | Yes |
| 0.20 | 0.01 | 0.79 | No | Yes |
| 0.25 | 0.35 | 0.40 | No | No |

The first row indicates that where condition X is present and condition Y is not present, the probability of the parameter (e.g., heart rate, blood pressure, etc.) being “high” is 5%, the probability of the parameter being “normal” is 5%, and the probability of the parameter being “low” is 90%. As described above, Data Agent can provide information as to whether any particular parameter (e.g., heart rate) is within any particular range, e.g., “high”, “normal” and “low”. In addition, when operating in an “orange” mode, the parameter can be considered to be:
“high” if the color code indicator is orange or red and the status is “increasing”;
“low” if the color code indicator is orange or red and the status is “decreasing”; and
“normal” otherwise (i.e., if the color code indicator is green or yellow).
   Similarly, when operating in a “yellow” mode, the parameter can be considered to be:
“high” if the color code indicator is yellow, orange or red and the status is “increasing”;
“low” if the color code indicator is yellow, orange or red and the status is “decreasing”; and
“normal” otherwise (i.e., if the color code indicator is green).

The PersonalNET component of the embodiments described above is designed based on expert knowledge and the particular system's integrated case. PersonalNET is developed preferably on the base of a Bayesian network frame. PersonalNET receives expert data (described above) and situation data, as well as real mode outputs and status records (as described above) from DataAgent, and it generates expert/situation reports. Situation data includes information which pertains to the specific system being monitored or evaluated. For example, where the system is a patient whose medical condition is being monitored, when the patient arrives at the ICU, PersonalNET learns about that patient and creates a probabilities table for that patient, e.g., by taking the following steps:
set up values characterizing the initial condition of the patient—this includes values defined by the doctor (for example: patient has signs of early septic shock), the patient's history, lab test results (if available) and values from the sensor(s);
based on this information, create a case file;
incorporate the case file; and
learn the incorporated case and adjust the probabilities table.
   The result is that the information in PersonalNET is shifted from the information in GeneralNET as a result of the information regarding the system (e.g., in the case of a patient, information regarding the condition of the patient). For example, in the case of a patient, based on expert information that elderly persons are more prone to high blood pressure, and situation information that the patient is elderly, PersonalNET could be designed to attribute less significance to a minor increase in the patient's blood pressure.

Input to PersonalNET can be in the form of a case file or a separate formatted case.

PersonalNET generates a report which is based on knowledge about the system (e.g., knowledge about the patient's condition when the patient arrives at the ICU) and PersonalNET evaluates the real mode outputs and the status records. The expert/situation report from PersonalNET shows the probabilities of possible emergency conditions. PersonalNET sends the expert/situation report to the ArbiterAgent.

When PersonalNET is in the form of a Bayesian network, the Bayesian network can be set up in any suitable format, and can function in a manner analogous to the manner described above with respect to when GeneralNET is in the form of a Bayesian network.

In the embodiments described above, PersonalNET can be updated by the request of ArbiterAgent. There are two methods to update PersonalNET:

PersonalNET receives a current status record as a new case and updates its probabilities table; or PersonalNET unlearns a previous case and then learns a new case. Preferably, PersonalNET is updated only when the system has significantly changed, or when a condition of the system has significantly changed. For example, if the system is a patient and the patient arrived in the ICU with Hypovolemia and currently has no signs of Hypovolemia, the patient's condition has changed, and PersonalNET can be updated for that patient.

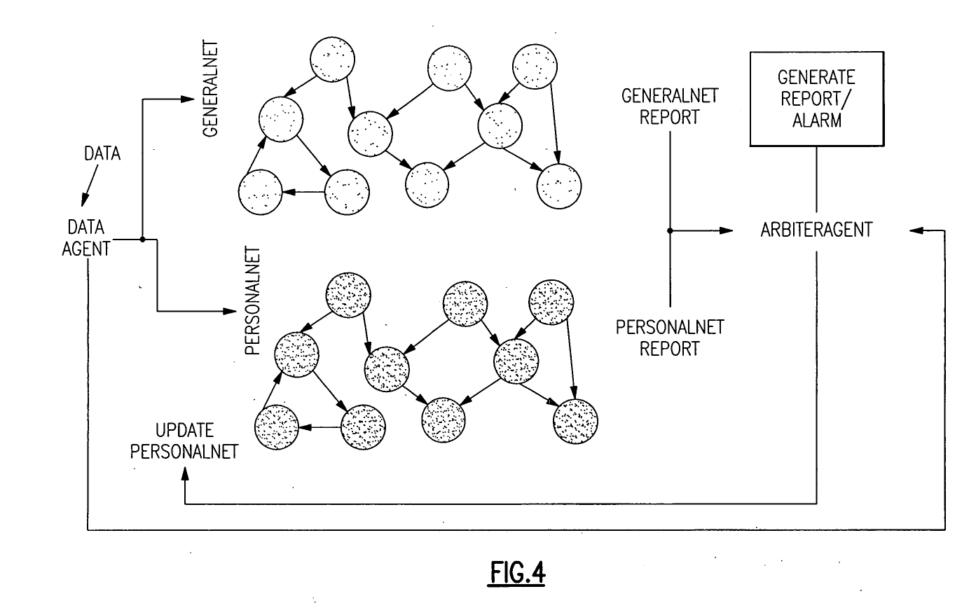

FIG. 4 depicts architecture within the embodiments described above relating in particular to GeneralNET and PersonalNET.

The ArbiterAgent of the embodiments described above makes decisions based on real mode records and status/color code records from said DataAgent, expert reports (from GeneralNET) and expert/situation reports (from PersonalNET). ArbiterAgent performs the following functions:
it makes final decisions (e.g., recommending a course of treatment);
it generates final reports and requests alarms, when necessary; and
it updates PersonalNET, when necessary.

ArbiterAgent of the inference engine according to the embodiments described above makes decisions and generates final reports based on the following information:
expert reports from GeneralNET;
expert/situation reports from PersonalNET; and
real mode records and status/color code records from DataAgent.

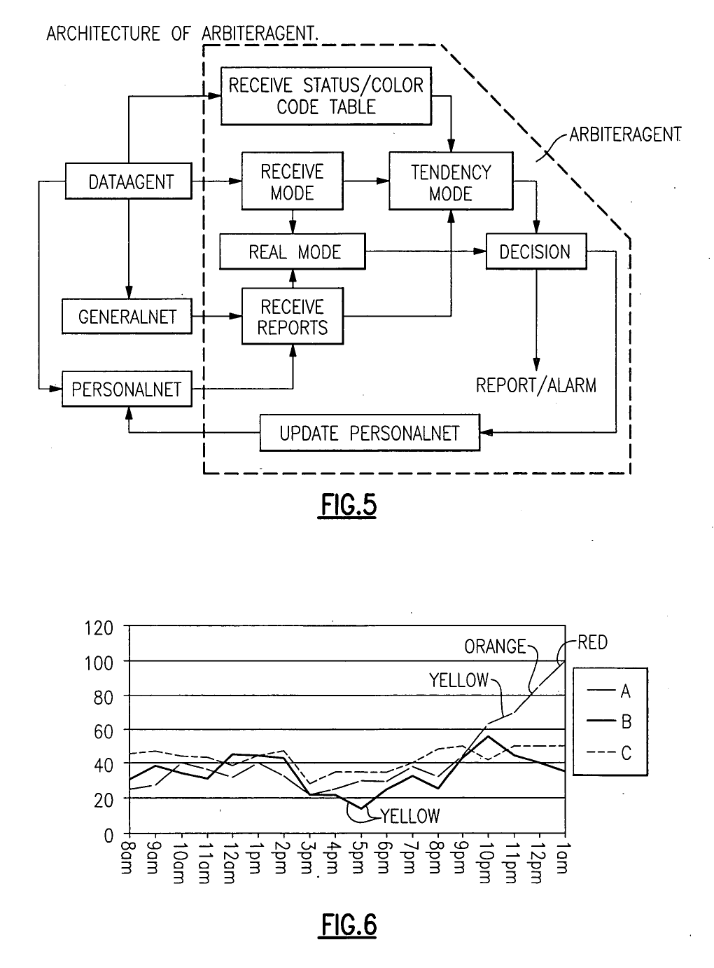

FIG. 5 depicts architecture of the ArbiterAgent according to the embodiments described above.

In the real mode of the embodiments described above, ArbiterAgent makes a final decision regarding each possible condition based on reports from GeneralNET and PersonalNET and the real mode records received from DataAgent. A separate method of decision-making is included in ArbiterAgent for each type of condition (e.g., shock). These methods are based on expert information, e.g., expertise of medical doctors, and are preferably adjusted after testing.

In the tendency mode of the embodiments described above, ArbiterAgent makes a final decision based on reports from GeneralNET and PersonalNET and the status/color code record from DataAgent. In this case, the problem is more complex and the severity of changes in readings becomes a very important factor. With active participation of domain experts, the patterns for each emergency condition are developed. Decisions are made based on comparing a summary of tendencies of changes for all readings and the pattern for a particular emergency condition.

In the embodiments described above, ArbiterAgent generates a final report, which includes:
probabilities of having any emergency conditions by the system being monitored; and
trends of increasing/decreasing values for particular parameters.

In the embodiments described above, ArbiterAgent preferably requires an alarm when:
the probability of any of the emergency conditions is high; or
a trend of increasing/decreasing values shows high probability of an emergency condition occurring in the near future.

Abnormal values of the readings show an increase of the severity of the problem.

To avoid false alarms, a summary of probabilities for all readings is preferably considered before an alarm is requested. When abnormal values of the readings continue to increase/decrease, the severity of the problem may be increasing and an alarm may therefore be required. However, if the value of the readings is abnormal, but steady, an alarm may be required once and a report indicating the problem can be generated continuously—but no further alarm is required.

In the embodiments described above, ArbiterAgent preferably requires an update of PersonalNet when the following information is received:
manually entered new diagnostic information-based on entered information, a new case file will be created and integrated, and PersonalNET will be adjusted; or
a report from PersonalNET shows a more severe problem than is shown in the report from GeneralNET, meaning that GeneralNET's configuration more accurately describes the system's current condition than PersonalNET's configuration. Example: a patient arrived at ICU with signs of early septic shock. In ICU he received drugs, and as a result is no longer in septic shock. In this case, because PersonalNET was adjusted with consideration of signs of septic shock, GeneralNET has more accurate information of the patient's condition than PersonalNET. At this point, PersonalNET should unlearn the previous case (case with septic shock) and learn the new case based on current information from sensors.

In the embodiments described above, generally, for a system operating in only the real mode (i.e., tendency mode is OFF), ArbiterAgent will make a decision to update PersonalNET for each emergency condition according to Table 1 shown below:

TABLE 1
Update of PersonalNET.

| GeneralNET | PersonalNet | Request |
|---|---|---|
| Negative | Negative | Do not update |
| Negative | Positive | Update |
| Positive | Negative | Do not update |
| Positive | Positive | Do not update |

Where:
“Negative” means a low probability of having a particular emergency condition.
“Positive” means a low probability of having a particular emergency condition.

In the embodiments described above, ArbiterAgent preferably creates such tables for each emergency condition and requests update knowledge about each emergency condition separately. However, if the system supports tendency mode, then the results are also considered according to the modified table (Table 2) shown below:

TABLE 2
update PersonalNET for System supporting tendency mode.

| Real Mode | | Tendency Mode | | |
|---|---|---|---|---|
| GeneralNET | PersonalNET | GeneralNET | PersonalNET | Request |
| Positive | Positive | * | * | Do not update |
| Positive | Negative | * | * | Do not update |
| Negative | Positive | Negative | * | Update |
| Negative | Positive | Positive | * | Do not update |
| Negative | Negative | * | * | Do not update |

Where:
“Negative” means low probability of having particular emergency condition.
“Positive” means low probability of having particular emergency condition.
“*” means regardless of the value of probability in particular case.

In the embodiments described above, ArbiterAgent preferably creates the tables described above for each emergency condition. For system supported tendency mode, ArbiterAgent requires updated information regarding each emergency condition separately according the table described above.

While the embodiments described above refer to specific examples where situation data is medical data regarding a patient, the present invention can be applied to any kind of situation data, e.g., data from sensors which monitor properties of or constituents in any system or element, and in which the expert data correspondingly is information relating to such system or element.

While the GeneralNET and PersonalNET components of the embodiments described above are Bayesian networks (which are conventionally known learning networks), either or both of these components can instead be any other learning network, e.g., a virtual vector machine, a neural network, a discrimination function, a decision tree, an expectation-maximization on mixtures of Gaussians, a probability distribution function (PDF), estimation through moment computation, PDF estimation through histograms, etc.

In addition, while the basic records, current records, decreasing current records, increasing current records, status/color code records, status records, real mode records and real mode outputs described above include specific data in specific respective formats, the types of data contained in each record and/or image can vary and can be in any desired format.

In addition, the time interval over which data is collected (and/or sub-intervals reflecting the period of time between each piece of data for a sensor) for generating a basic record can be selected from among a wide range of time periods, and/or can differ from one another for different parameters.

Also, the duration of time over which data is collected (and/or sub-intervals reflecting the period of time between each piece of data for a sensor) for generating current records, decreasing current records or increasing current records can be selected from among a wide range of time periods and/or can differ from one another.

Further, data (e.g., status, color code and/or readings) can be grouped differently for sending to other components (e.g., DataAgent can send PersonalNET a status/color code record which is similar to the status/color code record sent to ArbiterAgent).

Also, the number of range segments can be selected from among a wide range of quantities; in addition, it is not necessary that each of the segments have an equal range from lowest value to highest value.

The “minimum ratio” used in the basic record creation routine (i.e., the “minimum ratio of the quantity of data values in Rmax”) can be selected from within a wide range of quantities.

The percentages used in the decreasing current record creation routine (i.e., 30% for the first portion, 20% for the second portion and 50% for the third portion) and in the increasing current record creation routine (i.e., 50% for the first portion, 20% for the second portion and 30% for the third portion) can each vary from what is described in the above embodiments.

Also, the number of consecutive times for the color code to be yellow or the number of consecutive times for the color code to be orange for the option of automatically updating the basic record can be selected from among a wide range of values.

### EXAMPLE

FIG. 6 is a chart showing readings for a patient in the course of a hypothetical example. In this hypothetical example, the acceptable range for A, B and C readings is assumed to be from 10 to 80 and the basic range is assumed to be between 20 and 60. Referring to the chart, if for A it is detected that values are gradually increasing since 10:00 p.m., then the possible emergency at 12:20 a.m. can be prevented. However, to avoid false alarms, the system must be able to recognize when the values are just temporarily increasing or decreasing, and are caused by reasons other than the equipment condition. See, for example, the B values from 4:00 p.m. to 6:00 p.m. Within the basic range, the color code is “green”. With the exception of the portions of the chart which are marked “yellow”, “orange” or “red”, all of the portions in the chart shown in FIG. 6 are green. If values fall outside the basic range, then a possible problem is indicated. For effective problem detection, it is important to create methods that sense gradual increases and decreases of statistical average values because even when statistical values are within an acceptable range, if they are gradually moving in one direction or another, they can indicate a potential problem. The system's objective is to track even slightly changing values to predict and prevent potential problems, which allows the ICU staff more time to act before an emergency occurs. This is especially important in preventing emergencies which can occur very quickly (within minutes or seconds).

Any two or more functions can be conducted simultaneously, and/or any function can be conducted in a series of steps.

1. A method for converting data, comprising:
performing a MIN/MAX/Low/High/Acceptable detection routine, said MIN/MAX/Low/High/Acceptable detection routine comprising:
receiving a set of data values for a parameter;
assigning each data value which is less than a minimum possible value to a first category;
assigning each data value which is within an acceptable range of values to a second category;
assigning each data value which is greater than a maximum possible value to a third category;
assigning each data value which is at least as large as said minimum possible value and less than a lowest value in said acceptable range to a fourth category; and
assigning each data value which is not greater than said maximum possible value and which is greater than the highest value in said acceptable range to a fifth category;
if a number of data values in said fourth category exceeds a number of data values in said second category and exceeds a number of data values in said fifth category, assigning a first level to a first indicator, assigning a first status to a second indicator and again performing said MIN/MAX/Low/High/Acceptable detection routine;
if said number of data values in said fifth category exceeds said number of data values in said second category and is at least as large as said number of data values in said fourth category, assigning said first level to said first indicator, assigning a second status to said second indicator and again performing said MIN/MAX/Low/High/Acceptable detection routine;
if said number of data values in said second category is at least as large as said number of data values in said fourth category and is at least as large as said number of data values in said fifth category, performing a basic record creation routine, said basic record creation routine comprising:
dividing a range of values within said second category into a plural number of range segments;
for each of said range segments, determining a quantity of said data values which fall within said range segment;
characterizing a range segment having a maximum quantity of said data values as Rmax, and assigning said Rmax to a final range category;
performing a next range segment analysis, said next range segment analysis comprising:
if a next lower range segment has a greater quantity of data values than a quantity of data values in a next higher range segment, said next lower range segment including a highest range of values which is less than the lowest value in said final range category, said next higher range segment including a lowest range of values which is greater than the highest value in said final range category, and if said next lower range segment has a quantity of data values which is at least a minimum ratio of a quantity of data values in Rmax, adding said next lower range segment to said final range category and again performing said next range segment analysis;
if said quantity of data values in said next higher range segment is at least as large as said quantity of data values in said next lower range segment and is at least said minimum ratio of said quantity of data values in Rmax, adding said next higher range segment to said final range category and again performing said next range segment analysis;
if (a) said quantity of data values in said next lower range segment is greater than said quantity of data values in said next higher range segment, and said quantity of data values in said next lower range segment is less than said minimum ratio of said quantity of data values in Rmax, or (b) said quantity of data values in said next higher range segment is at least as large as said quantity of data values in said next lower range segment, and said quantity of data values in said next higher range segment is less than said minimum ratio of said quantity of data values in Rmax, performing a final range comparison routine, said final range comparison routine comprising:
if at least one range segment has a quantity of data values which is at least said minimum ratio of said quantity of data values in Rmax and is not included in said final range, reducing said number of range segments by one and again performing said basic record creation routine;
determining a quantity of said data values falling within a Low range, a quantity of said data values falling within an X range, a quantity of said data values falling within a Y range, a quantity of said data values falling within a Z range and a quantity of said data values falling within a High range,
said Low range including all values which are not less than said minimum possible value and which are less than said lowest value in said acceptable range,
said X range including all values which are at least as large as said lowest value in said acceptable range and less than a lowest value in said final range,
said Y range including all values which are within said final range,
said Z range including all values which are greater than a highest value in said final range and not larger than said highest value in said acceptable range; and
said High range including all values which are not greater than said maximum possible value and which are greater than said highest value in said acceptable range;
performing a current record creation routine, said current record creation routine comprising:
receiving a fresh set of data values for said parameter;
determining a Low value, said Low value being a quantity of data values within said fresh set of data values which fall within said Low range;
determining an X value, said X value being a quantity of data values within said fresh set of data values which fall within said X range;
determining a Y value, said Y value being a quantity of data values within said fresh set of data values which fall within said Y range;
determining a Z value, said Z value being a quantity of data values within said fresh set of data values which fall within said Z range;
determining a High value, said High value being a quantity of data values within said fresh set of data values which fall within said High range;
if said Low value is greater than each of said X value, said Y value, said Z value and said High value, assigning said first level to said first indicator, assigning said first status to said second indicator and proceeding to a decreasing current record creation routine;
if said High value is at least as large as said Low value, and greater than each of said X value, said Y value and said Z value, assigning said first level to said first indicator, assigning said second status to said second indicator and proceeding to an increasing current record creation routine;
if said X value is at least as large as said Low value and at least as large as said High value, and greater than each of said Y value and said Z value, assigning a second level to said first indicator, assigning said first status to said second indicator and proceeding to said decreasing current record creation routine;
if said Z value is at least as large as said Low value, at least as large as said High value, at least as large as said X value and greater than said Y value, assigning said second level to said first indicator, assigning said second status to said second indicator and proceeding to said increasing current record creation routine; and
if said Y value is at least as large as each of said Low value, said X value, said Z value and said High value, assigning a third level to said first indicator, assigning a third status to said second indicator and again performing said current record creation routine;
said decreasing current record creation routine comprising:
receiving a new fresh set of data values for said parameter;
determining a new Low value, said new Low value being a quantity of data values within said new fresh set of data values which fall within said Low range;
determining an X1 value, said X1 value being a quantity of data values within said new fresh set of data values which fall within a first portion of said X range;
determining an X2 value, said X2 value being a quantity of data values within said new fresh set of data values which fall within a second portion of said X range, said second portion of said X range including values which are greater than values in said first portion of said X range;
determining an X3 value, said X3 value being a quantity of data values within said new fresh set of data values which fall within a third portion of said X range, said third portion of said X range including values which are greater than values in said second portion of said X range;
determining a new Y value, said new Y value being a quantity of data values within said new fresh set of data values which fall within said Y range;
determining a new Z value, said new Z value being a quantity of data values within said new fresh set of data values which fall within said Z range;
determining a new High value, said new High value being a quantity of data values within said new fresh set of data values which fall within said High range;
if said new High value is greater than each of said new Low value, said X1 value, said X2 value, said X3 value, said new Y value and said new Z value, assigning said first level to said first indicator, assigning said second status to said second indicator and proceeding to said increasing current record creation routine;
if said new Low value is at least as large as said new High value, and greater than each of said X1 value, said X2 value, said X3 value, said new Y value and said new Z value, assigning said first level to said first indicator, assigning said first status to said second indicator and again performing said decreasing current record creation routine;
if said new Z value is at least as large as said new High value, at least as large as said new Low value, and greater than each of said X1 value, said X2 value, said X3 value and said new Y value, assigning said second level to said first indicator, assigning said second status to said second indicator and proceeding to said increasing current record creation routine;
if said X1 value is at least as large as said new Low value, at least as large as said new High value, at least as large as said new Z value, and greater than each of said X2 value, said X3 value and said new Y value, assigning a fourth level to said first indicator, assigning said first status to said second indicator and again performing said decreasing current record creation routine;
if said X2 value is at least as large as said new Low value, at least as large as said new High value, at least as large as said new Z value, at least as large as said X1 value, and greater than each of said X3 value and said new Y value, assigning said second level to said first indicator, assigning said first status to said second indicator and again performing said decreasing current record creation routine;
if said X3 value is at least as large as said new Low value, at least as large as said new High value, at least as large as said new Z value, at least as large as said X1 value, at least as large as said X2 value, and greater than said new Y value, assigning said second level to said first indicator, assigning said first status to said second indicator and again performing said decreasing current record creation routine; and
if said new Y value is at least as large as each of said new Low value, said X1 value, said X2 value, said X3 value, said new Z value and said new High value, assigning said third level to said first indicator, assigning said third status to said second indicator and again performing said current record creation routine;
said increasing current record creation routine comprising:
receiving a current fresh set of data values for said parameter;
determining a current Low value, said current Low value being a quantity of data values within said current fresh set of data values which fall within said Low range;
determining a current X value, said current X value being a quantity of data values within said current fresh set of data values which fall within said X range;
determining a current Y value, said current Y value being a quantity of data values within said current fresh set of data values which fall within said Y range;
determining a Z1 value, said Z1 value being a quantity of data values within said current fresh set of data values which fall within a first portion of said Z range;
determining a Z2 value, said Z2 value being a quantity of data values within said current fresh set of data values which fall within a second portion of said Z range, said second portion of said Z range including values which are greater than values in said first portion of said Z range;
determining a Z3 value, said Z3 value being a quantity of data values within said current fresh set of data values which fall within a third portion of said Z range, said third portion of said Z range including values which are greater than values in said second portion of said Z range;
determining a current High value, said current High value being a quantity of data values within said current fresh set of data values which fall within said High range;
if said current Low value is greater than each of said current X value, said current Y value, said Z1 value, said Z2 value, said Z3 value and said current High value, assigning said first level to said first indicator, assigning said first status to said second indicator and proceeding to said decreasing current record creation routine;
if said current High value is at least as large as said current Low value, and greater than each of said current X value, said current Y value, said Z1 value, said Z2 value and said Z3 value, assigning said first level to said first indicator, assigning said second status to said second indicator and again performing said increasing current record creation routine;
if said current X value is at least as large as said current Low value, at least as large as said current High value, and greater than each of said current Y value, said Z1 value, said Z2 value and said Z3 value, assigning said second level to said first indicator, assigning said first status to said second indicator and proceeding to said decreasing current record creation routine;
if said Z3 value is at least as large as said current Low value, at least as large as said current High value, at least as large as said current X value, and greater than each of said current Y value, said Z1 value and said Z2 value, assigning said fourth level to said first indicator, assigning said second status to said second indicator and again performing said increasing current record creation routine;
if said Z2 value is at least as large as said current Low value, at least as large as said current High value, at least as large as said current X value, at least as large as said Z3 value, and greater than each of said current Y value and said Z1 value, assigning said second level to said first indicator, assigning said second status to said second indicator and again performing said increasing current record creation routine;
if said Z1 value is at least as large as said current Low value, at least as large as said current High value, at least as large as said current X value, at least as large as said Z3 value, at least as large as said Z2 value, and greater than said current Y value, assigning said second level to said first indicator, assigning said second status to said second indicator and again performing said increasing current record creation routine; and
if said current Y value is at least as large as each of said current Low value, said current X value, said Z1 value, said Z2 value, said Z3 value and said current High value, assigning said third level to said first indicator, assigning said third status to said second indicator and again performing said current record creation routine.

2-8. (canceled)

9. A method for converting data, comprising:
performing a MIN/MAX/Low/High/Acceptable detection routine, said MIN/MAX/Low/High/Acceptable detection routine comprising:
receiving a set of data values for a parameter;
assigning each data value which is less than a minimum possible value to a first category;
assigning each data value which is within an acceptable range of values to a second category;
assigning each data value which is greater than a maximum possible value to a third category;
assigning each data value which is at least as large as said minimum possible value and less than a lowest value in said acceptable range to a fourth category; and
assigning each data value which is not greater than said maximum possible value and which is greater than the highest value in said acceptable range to a fifth category;
if a number of data values in said fourth category exceeds a number of data values in said second category and exceeds a number of data values in said fifth category, assigning a first level to a first indicator, assigning a first status to a second indicator and again performing said MIN/MAX/Low/High/Acceptable detection routine;
if said number of data values in said fifth category exceeds said number of data values in said second category and is at least as large as said number of data values in said fourth category, assigning said first level to said first indicator, assigning a second status to said second indicator and again performing said MIN/MAX/Low/High/Acceptable detection routine;
if said number of data values in said second category is at least as large as said number of data values in said fourth category and is at least as large as said number of data values in said fifth category, performing a basic record creation routine, said basic record creation routine comprising:
dividing a range of values within said second category into a plural number of range segments;
for each of said range segments, determining a quantity of said data values which fall within said range segment;
characterizing a range segment having a maximum quantity of said data values as Rmax, and assigning said Rmax to a final range category;
performing a next range segment analysis, said next range segment analysis comprising:
if a next lower range segment has a greater quantity of data values than a quantity of data values in a next higher range segment, said next lower range segment including a highest range of values which is less than the lowest value in said final range category, said next higher range segment including a lowest range of values which is greater than the highest value in said final range category, and if said next lower range segment has a quantity of data values which is at least a minimum ratio of a quantity of data values in Rmax, adding said next lower range segment to said final range category and again performing said next range segment analysis;
if said quantity of data values in said next higher range segment is at least as large as said quantity of data values in said next lower range segment and is at least said minimum ratio of said quantity of data values in Rmax, adding said next higher range segment to said final range category and again performing said next range segment analysis;
if (a) said quantity of data values in said next lower range segment is greater than said quantity of data values in said next higher range segment, and said quantity of data values in said next lower range segment is less than said minimum ratio of said quantity of data values in Rmax, or (b) said quantity of data values in said next higher range segment is at least as large as said quantity of data values in said next lower range segment, and said quantity of data values in said next higher range segment is less than said minimum ratio of said quantity of data values in Rmax, performing a final range comparison routine, said final range comparison routine comprising:
if at least one range segment has a quantity of data values which is at least said minimum ratio of said quantity of data values in Rmax and is not included in said final range, reducing said number of range segments by one and again performing said basic record creation routine;
determining a quantity of said data values falling within a Low range, a quantity of said data values falling within an X range, a quantity of said data values falling within a Y range, a quantity of said data values falling within a Z range and a quantity of said data values falling within a High range,
said Low range including all values which are not less than said minimum possible value and which are less than said lowest value in said acceptable range,
said X range including all values which are at least as large as said lowest value in said acceptable range and less than a lowest value in said final range,
said Y range including all values which are within said final range,
said Z range including all values which are greater than a highest value in said final range and not larger than said highest value in said acceptable range; and
said High range including all values which are not greater than said maximum possible value and which are greater than said highest value in said acceptable range;
performing a current record creation routine, said current record creation routine comprising:
receiving a fresh set of data values for said parameter;
determining a Low value, said Low value being a quantity of data values within said fresh set of data values which fall within said Low range;
determining an X value, said X value being a quantity of data values within said fresh set of data values which fall within said X range;
determining a Y value, said Y value being a quantity of data values within said fresh set of data values which fall within said Y range;
determining a Z value, said Z value being a quantity of data values within said fresh set of data values which fall within said Z range;
determining a High value, said High value being a quantity of data values within said fresh set of data values which fall within said High range;
if said Low value is greater than each of said X value, said Y value, said Z value and said High value, assigning said first level to said first indicator, assigning said first status to said second indicator and proceeding to a decreasing current record creation routine;
if said High value is at least as large as said Low value, and greater than each of said X value, said Y value and said Z value, assigning said first level to said first indicator, assigning said second status to said second indicator and proceeding to an increasing current record creation routine;
if said X value is at least as large as said Low value and at least as large as said High value, and greater than each of said Y value and said Z value, assigning a second level to said first indicator, assigning said first status to said second indicator and proceeding to said decreasing current record creation routine;
if said Z value is at least as large as said Low value, at least as large as said High value, at least as large as said X value and greater than said Y value, assigning said second level to said first indicator, assigning said second status to said second indicator and proceeding to said increasing current record creation routine; and
if said Y value is at least as large as each of said Low value, said X value, said Z value and said High value, assigning a third level to said first indicator, assigning a third status to said second indicator and again performing said current record creation routine;
said decreasing current record creation routine comprising:
receiving a new fresh set of data values for said parameter;
determining a new Low value, said new Low value being a quantity of data values within said new fresh set of data values which fall within said Low range;
determining an X1 value, said X1 value being a quantity of data values within said new fresh set of data values which fall within a first portion of said X range;
determining an X2 value, said X2 value being a quantity of data values within said new fresh set of data values which fall within a second portion of said X range, said second portion of said X range including values which are greater than values in said first portion of said X range;
determining an X3 value, said X3 value being a quantity of data values within said new fresh set of data values which fall within a third portion of said X range, said third portion of said X range including values which are greater than values in said second portion of said X range;
determining a new Y value, said new Y value being a quantity of data values within said new fresh set of data values which fall within said Y range;
determining a new Z value, said new Z value being a quantity of data values within said new fresh set of data values which fall within said Z range;
determining a new High value, said new High value being a quantity of data values within said new fresh set of data values which fall within said High range;
if said new High value is greater than each of said new Low value, said X1 value, said X2 value, said X3 value, said new Y value and said new Z value, assigning said first level to said first indicator, assigning said second status to said second indicator and proceeding to said increasing current record creation routine;
if said new Low value is at least as large as said new High value, and greater than each of said X1 value, said X2 value, said X3 value, said new Y value and said new Z value, assigning said first level to said first indicator, assigning said first status to said second indicator and again performing said decreasing current record creation routine;
if said new Z value is at least as large as said new High value, at least as large as said new Low value, and greater than each of said X1 value, said X2 value, said X3 value and said new Y value, assigning said second level to said first indicator, assigning said second status to said second indicator and proceeding to said increasing current record creation routine;
if said X1 value is at least as large as said new Low value, at least as large as said new High value, at least as large as said new Z value, and greater than each of said X2 value, said X3 value and said new Y value, assigning said first status to said second indicator, modifying said third portion of said X range to include all values which were within said second portion of said X range as well as all values which were within said third portion of said X range, dividing said first portion of said X range into a first X1 part and a second X1 part, said first X1 part having values lower than said second X1 part, said first X1 part becoming said first portion of said X range, said second X1 part becoming said second portion of said X range, and again performing said decreasing current record creation routine;
if said X2 value is at least as large as said new Low value, at least as large as said new High value, at least as large as said new Z value, at least as large as said X1 value, and greater than each of said X3 value and said new Y value, assigning said first status to said second indicator, modifying said third portion of said X range to include all values which were within said second portion of said X range as well as all values which were within said third portion of said X range, dividing said first portion of said X range into a first X2 part and a second X2 part, said first X2 part having values lower than said second X2 part, said first X2 part becoming said first portion of said X range, said second X2 part becoming said second portion of said X range, and again performing said decreasing current record creation routine;
if said X3 value is at least as large as said new Low value, at least as large as said new High value, at least as large as said new Z value, at least as large as said X1 value, at least as large as said X2 value, and greater than said new Y value, assigning said first status to said second indicator, modifying said first portion of said X range to include all values which were within said second portion of said X range as well as all values which were within said first portion of said X range, dividing said third portion of said X range into a first X3 part and a second X3 part, said first X3 part having values lower than said second X3 part, said first X3 part becoming said second portion of said X range, said second X3 part becoming said third portion of said X range, and again performing said decreasing current record creation routine; and
if said new Y value is at least as large as each of said new Low value, said X1 value, said X2 value, said X3 value, said new Z value and said new High value, assigning said third level to said first indicator, assigning said third status to said second indicator and again performing said current record creation routine;
said increasing current record creation routine comprising:
receiving a current fresh set of data values for said parameter;
determining a current Low value, said current Low value being a quantity of data values within said current fresh set of data values which fall within said Low range;
determining a current X value, said current X value being a quantity of data values within said current fresh set of data values which fall within said X range;
determining a current Y value, said current Y value being a quantity of data values within said current fresh set of data values which fall within said Y range;
determining a Z1 value, said Z1 value being a quantity of data values within said current fresh set of data values which fall within a first portion of said Z range;
determining a Z2 value, said Z2 value being a quantity of data values within said current fresh set of data values which fall within a second portion of said Z range, said second portion of said Z range including values which are greater than values in said first portion of said Z range;
determining a Z3 value, said Z3 value being a quantity of data values within said current fresh set of data values which fall within a third portion of said Z range, said third portion of said Z range including values which are greater than values in said second portion of said Z range;
determining a current High value, said current High value being a quantity of data values within said current fresh set of data values which fall within said High range;
if said current Low value is greater than each of said current X value, said current Y value, said Z1 value, said Z2 value, said Z3 value and said current High value, assigning said first level to said first indicator, assigning said first status to said second indicator and proceeding to said decreasing current record creation routine;
if said current High value is at least as large as said current Low value, and greater than each of said current X value, said current Y value, said Z1 value, said Z2 value and said Z3 value, assigning said first level to said first indicator, assigning said second status to said second indicator and again performing said increasing current record creation routine;
if said current X value is at least as large as said current Low value, at least as large as said current High value, and greater than each of said current Y value, said Z1 value, said Z2 value and said Z3 value, assigning said second level to said first indicator, assigning said first status to said second indicator and proceeding to said decreasing current record creation routine;
if said Z3 value is at least as large as said current Low value, at least as large as said current High value, at least as large as said current X value, and greater than each of said current Y value, said Z1 value and said Z2 value, assigning said second status to said second indicator, modifying said first portion of said Z range to include all values which were within said second portion of said Z range as well as all values which were within said first portion of said Z range, dividing said third portion of said Z range into a first Z3 part and a second Z3 part, said first Z3 part having values lower than said second Z3 part, said first Z3 part becoming said second portion of said Z range, said second Z3 part becoming said third portion of said Z range, and again performing said increasing current record creation routine;
if said Z2 value is at least as large as said current Low value, at least as large as said current High value, at least as large as said current X value, at least as large as said Z3 value, and greater than each of said Z1 value and said current Y value, assigning said second status to said second indicator, modifying said first portion of said Z range to include all values which were within said second portion of said Z range as well as all values which were within said first portion of said Z range, dividing said third portion of said Z range into a first Z2 part and a second Z2 part, said first Z2 part having values lower than said second Z2 part, said first Z2 part becoming said second portion of said Z range, said second Z2 part becoming said third portion of said Z range, and again performing said increasing current record creation routine;
if said Z1 value is at least as large as said current Low value, at least as large as said current High value, at least as large as said current X value, at least as large as said Z3 value, at least as large as said Z2 value, and greater than said current Y value, assigning said second status to said second indicator, modifying said third portion of said Z range to include all values which were within said second portion of said Z range as well as all values which were within said third portion of said Z range, dividing said first portion of said Z range into a first Z1 part and a second Z1 part, said first Z1 part having values lower than said second Z1 part, said first Z1 part becoming said first portion of said Z range, said second Z1 part becoming said second portion of said Z range, and again performing said increasing current record creation routine; and
if said current Y value is at least as large as each of said current Low value, said current X value, said Z1 value, said Z2 value, said Z3 value and said current High value, assigning said third level to said first indicator, assigning said third status to said second indicator and again performing said current record creation routine.

10-39. (canceled)

40. An apparatus comprising:
at least one sensor;
a data evaluation component which receives sensor data from said at least one sensor and which generates data information based on evaluation of said sensor data;
a general report generating component which receives data information from said data evaluation component and expert information, and which generates general reports based on said expert information and said data information;
a system-specific report generating component which receives information pertaining to said system and expert information, and which generates system-specific reports based on said expert information, said information pertaining to said system and data information received from said data evaluation component; and
a decision-making component which makes decisions based on data information from said data evaluation component, said general reports and said system-specific reports.

41-62. (canceled)

63. A method for converting data, comprising:
receiving a set of first data values for a parameter, said first data values being generated over a first period of time between a beginning of said first period of time and an end of said first period of time;
assigning each of said first data values to at least one of at least three initial ranges of values;
identifying at least one first data set maximum range, each said first data set maximum range being one of said initial ranges which has a maximum number of said first data values;
receiving a set of second data values for said parameter, said second data values being generated over a second period of time, at least a portion of said second period of time being subsequent to said end of said first period of time;
assigning each of said second data values to at least one of at least three later ranges of values;
identifying at least one second data set maximum range, each said second data set maximum range being one of said later ranges which has a maximum number of said second data values.

64. A method as recited in claim 63, further comprising comparing said at least one second data set maximum range with said at least one first data set maximum range.

65. A method as recited in claim 64, wherein said comparing said at least one second data set maximum range with said at least one first data set maximum range comprises determining whether said at least one second data set maximum range is substantially the same as said at least one first data set maximum range.

66. A method as recited in claim 64, wherein said comparing said at least one second data set maximum range with said at least one first data set maximum range comprises determining whether said at least one second data set maximum range differs from said at least one first data set maximum range.

67. A method as recited in claim 64, wherein said comparing said at least one second data set maximum range with said at least one first data set maximum range comprises determining whether at least a portion of said at least one second data set maximum range overlaps with at least a portion of said at least one first data set maximum range.

68. A method as recited in claim 64, wherein said comparing said at least one second data set maximum range with said at least one first data set maximum range comprises determining whether said at least one second data set maximum range encompasses said at least one first data set maximum range.

69. A method as recited in claim 64, wherein said comparing said at least one second data set maximum range with said at least one first data set maximum range comprises determining whether said at least one first data set maximum range encompasses said at least one second data set maximum range.

70. A method as recited in claim 63, wherein said initial ranges of values are substantially similar to said later ranges of values.

71. A method as recited in claim 70, further comprising receiving a set of third data values, and
if said second data set maximum range is different from said first data set maximum range, assigning each of said third data values to at least one of a group of current ranges of values, said current ranges of values being the same as said at least three later ranges, except that said second data set maximum range is divided into at least two current ranges;
if said second data set maximum range is the same as said first data set maximum range, assigning each of said third data values to at least one of said at least three later ranges.

72. A method as recited in claim 71, further comprising identifying at least one third data set maximum range, each said third data set maximum range being one of said current ranges of values which has a maximum number of said third data values.

73. A method as recited in claim 63, wherein said parameter is a medical parameter of a patient.

74. A method as recited in claim 63, wherein said at least three initial ranges of values are the same as said at least three later ranges of values.

75. A method as recited in claim 63, wherein endpoints of a basic value range, said basic value range being one of said initial ranges of values, are determined by:
for each of a number of range segments, determining a quantity of a set of basic data values which fall within said range segment;
characterizing a range segment having a maximum quantity of said basic data values as Rmax, and assigning said Rmax to a final range category; and
performing a next range segment analysis, said next range segment analysis comprising:
if a next lower range segment has a greater quantity of basic data values than a quantity of basic data values in a next higher range segment, said next lower range segment including a highest range of values which is less than the lowest value in said final range category, said next higher range segment including a lowest range of values which is greater than the highest value in said final range category, and if said next lower range segment has a quantity of basic data values which is at least a minimum ratio of a quantity of basic data values in Rmax, adding said next lower range segment to said final range category and again performing said next range segment analysis;
if said quantity of basic data values in said next higher range segment is at least as large as said quantity of basic data values in said next lower range segment and is at least said minimum ratio of said quantity of basic data values in Rmax, adding said next higher range segment to said final range category and again performing said next range segment analysis;
if (a) said quantity of basic data values in said next lower range segment is greater than said quantity of basic data values in said next higher range segment, and said quantity of basic data values in said next lower range segment is less than said minimum ratio of said quantity of basic data values in Rmax, or (b) said quantity of basic data values in said next higher range segment is at least as large as said quantity of basic data values in said next lower range segment, and said quantity of basic data values in said next higher range segment is less than said minimum ratio of said quantity of basic data values in Rmax, performing a final range comparison routine, said final range comparison routine comprising:
if at least one range segment has a quantity of basic data values which is at least said minimum ratio of said quantity of basic data values in Rmax and is not included in said final range, reducing said number of range segments by one and again performing said basic record creation routine;
if every range segment which has a quantity of basic data values which is at least said minimum ratio of said quantity of basic data values in Rmax is included in said final range, defining endpoints of said basic value range to be the same as endpoints of said final range.

76. A method as recited in claim 75, wherein said set of basic data values is said set of first data values.

77. A method as recited in claim 75, wherein said basic data values are generated in a basic time interval, said basic time interval preceding said first period of time.

78-99. (canceled)

100. A method for converting data, comprising performing a basic record creation routine comprising:
receiving a set of first data values for a parameter, said first data values being generated over a first period of time between a beginning of said first period of time and an end of said first period of time;
for each of a number of range segments, determining a quantity of said first data values which fall within said range segment;
characterizing a range segment having a maximum quantity of said first data values as Rmax, and assigning said Rmax to a final range category;
performing a next range segment analysis, said next range segment analysis comprising:
if a next lower range segment has a greater quantity of first data values than a quantity of first data values in a next higher range segment, said next lower range segment including a highest range of values which is less than the lowest value in said final range category, said next higher range segment including a lowest range of values which is greater than the highest value in said final range category, and if said next lower range segment has a quantity of first data values which is at least a minimum ratio of a quantity of first data values in Rmax, adding said next lower range segment to said final range category and again performing said next range segment analysis;
if said quantity of first data values in said next higher range segment is at least as large as said quantity of first data values in said next lower range segment, and if said quantity of first data values in said next higher range segment is at least said minimum ratio of said quantity of first data values in Rmax, adding said next higher range segment to said final range category and again performing said next range segment analysis;
if (a) said quantity of first data values in said next lower range segment is greater than said quantity of first data values in said next higher range segment, and said quantity of first data values in said next lower range segment is less than said minimum ratio of said quantity of first data values in Rmax, or (b) said quantity of first data values in said next higher range segment is at least as large as said quantity of first data values in said next lower range segment, and said quantity of first data values in said next higher range segment is less than said minimum ratio of said quantity of first data values in Rmax, performing a final range comparison routine, said final range comparison routine comprising:
if at least one range segment has a quantity of first data values which is at least said minimum ratio of said quantity of first data values in Rmax and is not included in said final range, reducing said number of range segments by one and again performing said basic record creation routine;
if every range segment which has a quantity of first data values which is at least said minimum ratio of said quantity of first data values in Rmax is included in said final range, defining endpoints of a basic value range to be the same as endpoints of said final range;
receiving a set of second data values for said parameter, said second data values being generated over a second period of time, at least a portion of said second period of time being subsequent to said end of said first period of time;
assigning each of said second data values to one of at least three value ranges, one of said value ranges being said basic value range;
identifying a second data set maximum range, said second data set maximum range being one of said value ranges which has a maximum quantity of said second data values.

101-103. (canceled)

104. A computer-readable medium having computer-executable components, comprising:
means for receiving a set of first data values for a parameter, said first data values being generated over a first period of time between a beginning of said first period of time and an end of said first period of time;
means for assigning each of said first data values to at least one of at least three initial ranges of values;
means for identifying at least one first data set maximum range, each said first data set maximum range being one of said initial ranges which has a maximum number of said first data values;
means for receiving a set of second data values for said parameter, said second data values being generated over a second period of time, at least a portion of said second period of time being subsequent to said end of said first period of time;
means for assigning each of said second data values to at least one of at least three later ranges of values;
means for identifying at least one second data set maximum range, each said second data set maximum range being one of said later ranges which has a maximum number of said second data values.

105-114. (canceled)

115. A computer-readable medium having stored therein at least one computer program for carrying out a method as recited in claim 63.

116. A method as recited in claim 63, wherein said method is computer-implemented.

117-119. (canceled)

120. A method as recited in claim 63, further comprising obtaining data values from a sensor prior to said receiving a set of first data values for a parameter.

121-124. (canceled)

125. A computer-readable medium comprising computer instructions which, when executed by a computer, perform a method as recited in claim 63.

126. A processor on which is stored software for carrying out a method as recited in claim 63.

127-129. (canceled)

130. A method as recited in claim 63, further comprising sending a report after said identifying at least one second data set

131-132. (canceled)

133. An apparatus comprising a computer-readable medium as recited in claim 104, further comprising at least one alarm which is activated when an emergency is detected or predicted.
